(19) United States
(12) Patent Application Publication
(10) Pub. No.: US 2025/0339782 A1
(43) Pub. Date: Nov. 6, 2025

(54) VIRTUAL OBJECT CONTROL METHOD AND APPARATUS, ELECTRONIC DEVICE, COMPUTER-READABLE STORAGE MEDIUM, AND COMPUTER PRODUCT

(71) Applicant: Tencent Technology (Shenzhen) Company Limited, Shenzhen (CN)

(72) Inventors: Ying DENG, Shenzhen (CN); Wenbin DAI, Shenzhen (CN)

(21) Appl. No.: 19/266,047

(22) Filed: Jul. 10, 2025

Related U.S. Application Data
(63) Continuation of application No. PCT/CN2024/098723, filed on Jun. 12, 2024.

(30) Foreign Application Priority Data
Aug. 24, 2023 (CN) 202311078624.0

(51) Int. Cl. A63F 13/803; A63F 13/2145; A63F 13/42

(52) U.S. Cl. CPC A63F 13/803; A63F 13/2145; A63F 13/42

(57) ABSTRACT

A virtual object control method performed by an electronic device a non-transitory computer-readable storage medium is provided. The method includes: displaying a virtual object in a virtual scene, and displaying a driving control and a direction control, the driving control being configured to control the virtual object to travel forward or backward, and the direction control being configured to control the virtual object to make a turn; controlling, in response to a co-connection instruction for the driving control and the direction control, the driving control and the direction control to be in a co-connected state; and controlling, in response to a trigger operation for a target control, the virtual object to make a turn while traveling when the driving control and the direction control are in the co-connected state, the target control being at least one of the driving control and the direction control.

### CROSS-REFERENCE TO RELATED APPLICATIONS

This application is a continuation application of PCT Patent Application No. PCT/CN2024/098723, entitled “VIRTUAL OBJECT CONTROL METHOD AND APPARATUS, ELECTRONIC DEVICE, COMPUTER-READABLE STORAGE MEDIUM, AND COMPUTER PRODUCT” filed on Jun. 12, 2024, which claims priority to Chinese Patent Application No. 202311078624.0, “VIRTUAL OBJECT CONTROL METHOD AND APPARATUS, ELECTRONIC DEVICE, COMPUTER-READABLE STORAGE MEDIUM, AND COMPUTER PRODUCT” filed on Aug. 24, 2023, both of which are incorporated herein by reference in their entirety.

### FIELD OF THE TECHNOLOGY

This application relates to the field of virtualization and human-computer interaction technologies, and in particular, to a virtual object control method and apparatus, an electronic device, a non-transitory computer-readable storage medium, and a computer program product.

### BACKGROUND OF THE DISCLOSURE

In the related art, in a mobile game, when a player is driving a virtual vehicle, the player can turn left and turn right by simultaneously clicking/tapping a forward or backward button and a left direction button or a right direction button. However, the manner of repeatedly clicking/tapping the forward or backward button and the left direction button or the right direction button to adjust a steering process of the virtual vehicle is excessively cumbersome, and convenience of an interactive operation is relatively low. In addition, the steering process of the virtual vehicle can be implemented only through cumbersome operations, which also causes a waste of hardware processing resources.

### SUMMARY

Embodiments of this application provide a virtual object control method and apparatus, an electronic device, a non-transitory computer-readable storage medium, and a computer program product, to improve convenience of an interactive operation, human-computer interaction efficiency, and utilization of hardware processing resources.

Technical solutions in the embodiments of this application are implemented as follows.

An embodiment of this application provides a virtual object control method performed by an electronic device, the method including:
displaying a virtual object, a driving control and a direction control in a virtual scene;
in response to a co-connection instruction for the driving control and the direction control, controlling the driving control and the direction control to be in a co-connected state; and
in response to a trigger operation for a target control, controlling the virtual object to make a turn while traveling when the driving control and the direction control are in the co-connected state,
the target control being at least one of the driving control and the direction control.

An embodiment of this application provides an electronic device, including:
a memory, configured to store a computer-executable instruction; and
a processor, configured to implement the virtual object control method provided in the embodiments of this application when executing the computer-executable instruction stored in the memory.

An embodiment of this application provides a non-transitory computer-readable storage medium, having a computer-executable instruction stored therein, the computer-executable instruction, when executed by a processor, implementing the virtual object control method provided in the embodiments of this application.

The embodiments of this application have the following beneficial effects.

In response to a co-connection instruction for a driving control configured to control the virtual object to travel forward or backward and a direction control configured to control the virtual object to turn left or turn right, the driving control and the direction control are controlled to be in the co-connected state. In this way, when the driving control and the direction control are in the co-connected state, in response to the trigger operation for at least one of the driving control and the direction control, the virtual object is controlled to make a turn while traveling. In this way, compared with the manner in the related art in which the driving control and the direction control need to be repeatedly clicked/tapped to adjust the steering process, the driving control and the direction control are controlled to be in the co-connected state, so that only the driving control or the direction control is triggered to implement an effect of controlling the virtual object to make a turn while traveling, thereby improving convenience and effectiveness of the interactive operation, reducing a quantity of adjustment operations performed by the user in the steering process, and improving human-machine interaction efficiency and increasing a utilization rate of hardware resources of the electronic device.

### BRIEF DESCRIPTION OF THE DRAWINGS

FIG. 1 is a schematic diagram of a virtual object control system according to an embodiment of this application.

FIG. 2 is a schematic structural diagram of an electronic device according to an embodiment of this application.

FIG. 3 is a schematic flowchart of a virtual object control method according to an embodiment of this application.

FIG. 4 is a schematic diagram of a process for displaying a virtual object according to an embodiment of this application.

FIG. 5 is a schematic diagram of a driving control and a direction control according to an embodiment of this application.

FIG. 6 is a schematic diagram of a trigger operation simultaneously performed in a driving control and a direction control according to an embodiment of this application.

FIG. 7 is a schematic diagram of a first driving sub-control and a first direction sub-control in a target style according to an embodiment of this application.

FIG. 8 is a schematic diagram showing a steering angle adjustment control according to an embodiment of this application.

FIG. 9 is a schematic diagram of determining a central angle based on a steering angle adjustment control according to an embodiment of this application.

FIG. 10 is a schematic diagram of an orientation pointer according to an embodiment of this application.

FIG. 11 is a schematic diagram of adjusting a steering angle of a virtual object according to an embodiment of this application.

FIG. 12 is a schematic diagram of a guide line according to an embodiment of this application.

FIG. 13 is a schematic diagram of a process for determining a guide line corresponding to a virtual object according to an embodiment of this application.

FIG. 14 is a schematic diagram of first prompt information according to an embodiment of this application.

FIG. 15 is a schematic diagram of a state switching control according to an embodiment of this application.

FIG. 16 is a flowchart of a process of convenient steering of a vehicle in a game according to an embodiment of this application.

FIG. 17 is a schematic diagram of a current steering angle of a vehicle according to an embodiment of this application.

FIG. 18 is a schematic diagram of a direction angle according to an embodiment of this application.

### DESCRIPTION OF EMBODIMENTS

To make objectives, technical solutions, and advantages of this application clearer, embodiment of this application is described in further detail with reference to drawings. The described embodiments are not to be construed as a limitation on the embodiment of this application. All other embodiments obtained by a person of ordinary skill in the art without creative efforts fall within the protection scope of this application.

In the following description, a term “some embodiments” involved describes subsets of all possible embodiments, but “some embodiments” may be the same subset or different subsets of all of the possible embodiments, and may be combined with each other without conflict.

In the following description, a term “first/second/third” involved is merely configured for distinguishing between similar objects and does not represent a specific order of objects. “First/second/third” may be transposed for a specific order or a sequence when allowed, so that the embodiments of this application described herein can be implemented in an order other than those illustrated or described herein.

Unless otherwise defined, meanings of all technical and scientific terms used in this specification are the same as those usually understood by a person skilled in the art to which this application belongs. The terms used in this specification are merely intended to describe objectives of the embodiments of this application, and are not intended to limit this application.

Before the embodiments of this application are further described in detail, terms involved in the embodiments of this application are described. The terms involved in the embodiments of this application are applicable to the following explanations.

1) In response to: It is configured for indicating a condition or a state on which one or more to-be-performed operations rely. When the condition or the state is satisfied, the one or more operations may be performed in real time or have a set delay. Unless otherwise specified, an order in which a plurality of operations are performed is not limited.

2) Client: it is also referred to as a user side, is a program corresponding to a server that provides a local service to a user. In addition to some applications (APPs) that can only run locally, the client is generally installed on a terminal and needs to cooperate with the server to run. In other words, the client requires a corresponding server and service program in a network to provide a corresponding service. In this way, a specific communication connection needs to be established on the client and a server side to ensure a normal operation of an APP, for example a virtual scene client (such as a game client) and a video client.

3) Third-person perspective: It is a perspective from which a player and all battle elements within a specific surrounding environment may be seen in a picture when an in-game camera is at a specific distance behind a player character.

4) Virtual scene: It is a virtual scene displayed (or provided) when an APP runs on a terminal. The virtual scene may be a simulation environment for the real world, or may be a semi-simulation and semi-fiction virtual environment, and may further be a purely fictional virtual environment. The virtual scene may be any one of a two-dimensional virtual scene, a 2.5-dimensional virtual scene, or a three-dimensional virtual scene.

For example, the virtual scene may include sky, land, ocean, and the like. The land may include environmental elements such as desert and city, and a user may control a virtual object to perform an activity in the virtual scene. The activity includes, but is not limited to at least one of adjusting a body posture, crawling, walking, running, riding, jumping, driving, pickup, shooting, attacking, and throwing. The virtual scene may be displayed from a first-person perspective (for example, a user plays a role of a virtual object in a game from the perspective of the user); or the virtual scene may be displayed from a third-person perspective (for example, a game is played with the user chasing the virtual object in the game); and the virtual scene may further be displayed from a bird's-eye view. The foregoing perspectives may be switched randomly.

5) Virtual object: The virtual objects are images of various people and things that may interact in a virtual scene, or movable objects in the virtual scene. The movable objects may be a virtual person, a virtual animal, a cartoon character, and the like, for example, a character, an animal, a plant, an oil barrel, a wall, a rock, or a vehicle displayed in the virtual scene. The virtual object may be a virtual image for representing a user in the virtual scene. The virtual scene may include a plurality of virtual objects, and each virtual object has a shape and a volume in the virtual scene, and occupies some space in the virtual scene.

For example, the virtual object may be a user character controlled through an operation on a client, or may be an artificial intelligence (AI) character set in a virtual scene fight through training, and may further be a non-player character (NPC) set in virtual scene interaction. A quantity of virtual objects participating in interaction in the virtual scene may be preset, or may be dynamically determined based on a quantity of clients participating in the interaction.

6) Curvature circle: a point D is taken on a normal line of a point M on a curve and on a side of the concavity, so that DM is equal to a curvature radius at the point; a circle is made with D as a circle center and DM as a radius, and the circle is referred to as the curvature circle of the curve at this point.

7) Driving control: It is configured to control a player to travel forward or backward, for example, may be a forward control configured to control the player to travel forward, and a backward control configured to control the player to travel backward.

8) Direction control: It is a control configured to control steering of a player, for example, may be a left-turn control configured to control turning left of a player, and a right-turn control configured to control turning right of a player.

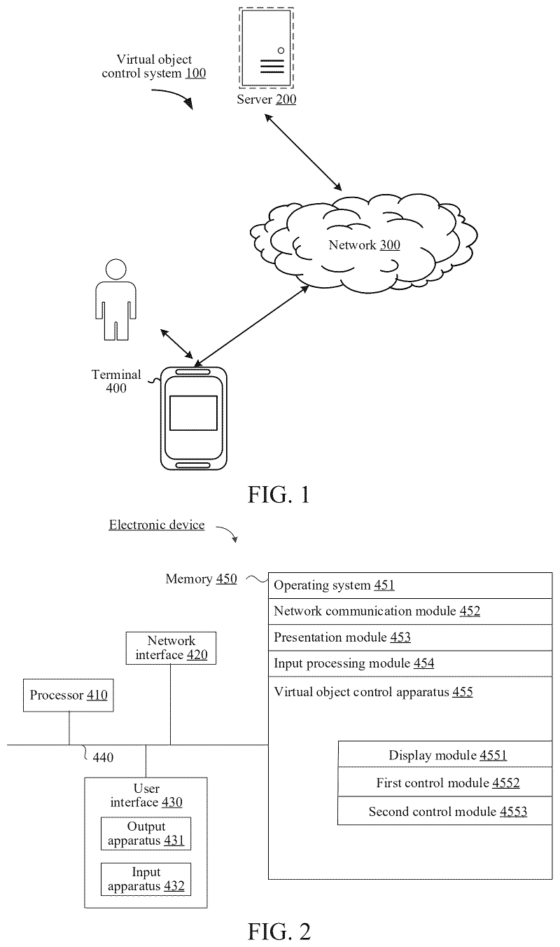

FIG. 1 is a schematic diagram of a virtual object control system 100 according to an embodiment of this application. To implement an application scene of controlling a virtual object (for example, the application scene of controlling a virtual object may be that when a user controls a virtual vehicle in a game, a forward button and a right-turn button are controlled to be in a co-connected state by simultaneously pressing the forward button and the right-turn button. In this way, when the forward button and the right-turn button are in the co-connected state, the virtual vehicle is controlled to turn right while traveling in response to a trigger operation for the forward button or the right-turn button), a terminal (a terminal 400 is exemplarily shown) is connected to a server 200 through a network 300. The network 300 may be a wide area network, a local area network, or a combination thereof. Data transmission is implemented through a wireless link or a wired link.

The server 200 is configured to transmit scene data corresponding to a virtual scene including a virtual object, a driving control configured to control a traveling direction of the virtual object, and a direction control to the terminal 400.

The terminal 400 is configured to: receive scene data corresponding to a virtual scene including a virtual object, a driving control configured to control a traveling direction of the virtual object, and a direction control; display the virtual scene based on the scene data; display the virtual object in the virtual scene, and display a driving control and a direction control, the driving control being configured to control the virtual object to travel forward or backward, and the direction control being configured to control the virtual object to make a turn; control, in response to a co-connection instruction for the driving control and the direction control, the driving control and the direction control to be in a co-connected state; and control, in response to a trigger operation for a target control, the virtual object to make a turn while traveling when the driving control and the direction control are in the co-connected state, the target control being at least one of the driving control and the direction control.

In some embodiments, the server 200 may be an independent physical server, a server cluster formed by a plurality of physical servers, a distributed system, or a cloud server that provides basic cloud computing services such as a cloud service, a cloud database, cloud computing, a cloud function, cloud storage, a network service, cloud communication, a middleware service a domain name service, a security service, a content delivery network (CDN), big data, and an AI platform. The terminal 400 may be a smartphone, a tablet computer, a notebook computer, a desktop computer, a set-top box, an intelligent voice interactive device, a smart home appliance, a virtual reality device, an on-board terminal, an aircraft, a portable music player, a personal digital assistant, a dedicated messaging device, a portable game device, a smart speaker, a smartwatch, or the like, but is not limited thereto. The terminal and the server may be directly or indirectly connected in a manner of wired or wireless communication, which is not limited in the embodiments of this application.

Next, an electronic device implementing the virtual object control method provided in the embodiments of this application is described. FIG. 2 is a schematic structural diagram of an electronic device according to an embodiment of this application. The electronic device may be a server or a terminal. An example in which the electronic device is the terminal shown in FIG. 1 is used. The electronic device shown in FIG. 2 includes at least one processor 410, a memory 450, at least one network interface 420, and a user interface 430. Various components in the terminal 400 are coupled together through a bus system 440. The bus system 440 is configured to implement connection and communication between the components. In addition to a data bus, the bus system 440 further includes a power bus, a control bus, and a state signal bus. However, for the sake of clarity, all buses are marked as the bus system 440 in FIG. 2.

The processor 410 may be an integrated circuit chip with a signal processing capability, for example, a general-purpose processor, a digital signal processor (DSP), another programmable logic device, a discrete gate or a transistor logic device, a discrete hardware component, or the like. The general-purpose processor may be a microprocessor, any conventional processor, or the like.

The user interface 430 includes one or more output apparatuses 431 that enable display of media content, including one or more speakers and/or one or more visual display screens. The user interface 430 further includes one or more input apparatuses 432, including user interface components that facilitate user input, such as a keyboard, a mouse, a microphone, a touch screen display, a camera, and another input button and control.

The memory 450 may be removable, non-removable, or a combination thereof. An exemplary hardware device includes a solid-state memory, a hard disk driver, an optical disk driver, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM). The volatile memory may be a random access memory (RAM). The memory 450 described in this embodiment of this application is intended to include any suitable type of memory.

In some embodiments, the memory 450 can store data to support various operations. Examples of the data include a program, a module, and a data structure, or a subset or a superset thereof. An exemplary description is provided below.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device includes device through one or more (wired or wireless) network interfaces 420. An exemplary network interface 420 includes Bluetooth, wireless fidelity (Wi-Fi), a universal serial bus (USB), and the like.

A presentation module 453 is configured to enable display of information through the one or more output apparatuses 431 (for example, a display screen and a speaker) associated with the user interface 430 (for example, a user interface configured to operate a peripheral device and display content and information).

An input processing module 454 is configured to detect user inputs or interactions from one or more input apparatuses 432 and translate the detected inputs or interactions.

In some embodiments, an apparatus provided in this embodiment of this application may be implemented by software. FIG. 2 shows a virtual object control apparatus 455 stored in the memory 450, which may be software in the form of programs and plug-ins, including the following software modules: a display module 4551, a first control module 4552, and a second control module 4553. The modules are logical modules. Therefore, the modules may be combined in different manners or further split based on functions to be implemented by the modules. Functions of the modules are described below.

In some other embodiments, the apparatus provided in the embodiments of this application may be implemented by hardware. In an example, the virtual object control apparatus provided in the embodiments of this application may be a processor in the form of a hardware decoding processor, which is programmed to perform the virtual object control method provided in the embodiments of this application. For example, the processor in the form of the hardware decoding processor may be one or more application specific integrated circuits (ASICs), a DSP, a programmable logic device (PLD), a complex programmable logic device (CPLD), a field-programmable gate array (FPGA), or another electronic element.

In some embodiments, the terminal or the server may implement the virtual object control method provided in embodiments of this application by running a computer program. For example, the computer program may be a native program or a software module in an operating system, or may be a native APP, i.e., a local client, to be specific, a program that needs to be installed in the operating system to run, such as an instant messaging APP or a web browser APP, or may be an applet, to be specific, a program that only needs to be downloaded into a browser environment to run, or may further be an applet that can be embedded in any APP. In a word, the foregoing computer program may be any form of client, module, or plug-in.

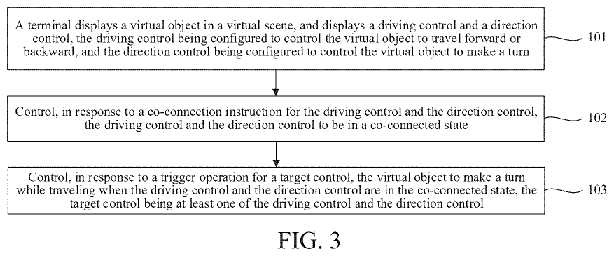

Based on the foregoing descriptions of the virtual object control system and the electronic device provided in the embodiments of this application, the following describes the virtual object control method provided in the embodiments of this application. During actual implementation, the virtual object control method provided in the embodiments of this application may be implemented by a terminal or a server alone, or may be implemented by the terminal and the server collaboratively. A description is provided by using an example in which the terminal 400 in FIG. 1 separately performs the virtual object control method provided in the embodiments of this application. FIG. 3 is a schematic flowchart of a virtual object control method according to an embodiment of this application. Next, a description is provided with reference to operations shown in FIG. 3.

Operation 101: A terminal displays a virtual object in a virtual scene, and displays a driving control and a direction control, the driving control being configured to control the virtual object to travel forward or backward, and the direction control being configured to control the virtual object to make a turn.

During actual implementation, an APP supporting the virtual scene is installed on the terminal. The APP may be any one of a first-person shooting game, a third-person shooting game, a multiplayer online battle arena, a virtual reality APP, a three-dimensional map program, and a multiplayer gunfight survival game. A user may use the terminal to operate the virtual object located in the virtual scene to perform an activity.

When the user opens an APP on the terminal and the terminal runs the APP, the terminal presents a picture of a virtual scene (such as a driving game scene). The picture of the virtual scene herein is obtained by observing the virtual scene from a first-person object perspective, or is obtained by observing the virtual scene from a third-person perspective. The picture of the virtual scene includes the virtual object. The virtual object may be a player character controlled by a user account that currently logs in to the APP. For example, the virtual object may be a player character controlled by the user that enters a driving game or a simulated virtual scene, or may be a virtual vehicle carrying a player character controlled by a user account that currently logs in to an APP. The virtual vehicle may assist the player character in traveling in the virtual scene. Common virtual vehicles include a virtual car, a virtual ship, a virtual plane, and the like. The virtual scene herein may further include another virtual object or interactive object, which may be controlled by another user or by a robot program. This is not limited in the embodiments of this application.

In some embodiments, when the virtual object is the virtual vehicle, the player character controlled by the user account that currently logs in to the APP and the vehicle control may further be displayed in the virtual scene before the virtual object is displayed, to control the player character to enter the virtual vehicle in response to the trigger operation for the vehicle control, i.e., control the player character to be in a vehicle driving mode, and further display the virtual object. Exemplarily, FIG. 4 is a schematic diagram of a process for displaying a virtual object according to an embodiment of this application. Based on FIG. 4, a dashed-line box 401 indicates a player character controlled by a user account that currently logs in to an APP, and a dashed-line box 402 indicates a vehicle control. In this way, the player character is controlled to enter a virtual vehicle such as an automobile in response to a trigger operation for the vehicle control indicated by the dashed-line box 402, thereby displaying the virtual object, i.e., the automobile carrying the player character.

When the vehicle control controlled by the user account that currently logs in to the APP and the player character are displayed, the virtual vehicle is further displayed. Then, the player character is controlled to travel toward the virtual vehicle in response to a traveling instruction for the player character. The vehicle control is displayed when the player character travels to a sensing range of the virtual vehicle. The sensing range of the virtual vehicle may be a circular area or a rectangular area. for example, the sensing range may be a circular area with a position of the virtual vehicle as a center and a target distance as a radius. The target distance herein is preset, for example, 5 meters.

A process of determining that the player character is within the sensing range of the virtual vehicle may include the following. The terminal obtains a position of the player character in the virtual scene, a position of the virtual vehicle, and the sensing range of the virtual vehicle; determines a distance between the player character and the virtual vehicle based on the position of the player character in the virtual scene and the position of the virtual vehicle; and determines that the player character is within the sensing range of the virtual vehicle based on this distance.

During actual implementation, after the position of the player character in the virtual scene, the position of the virtual vehicle, and the sensing range of the virtual vehicle are obtained, the distance between the player character and the virtual vehicle is obtained based on the position of the player character and the position of the virtual vehicle. The distance is compared with the target distance indicated by the sensing range of the virtual vehicle. Therefore, when the distance is less than or equal to the target distance indicated by the sensing range of the virtual vehicle, it is determined that the player character is within the sensing range of the virtual vehicle. When the distance is greater than the target distance indicated by the sensing range of the virtual vehicle, it is determined that the player character is not within the sensing range of the virtual vehicle.

During actual implementation, the terminal may further display, in an interface of the virtual scene, a driving control configured to control a traveling direction of the virtual object and a direction control. The driving control is configured to control the virtual object to travel forward or backward, and the direction control is configured to control the virtual object to turn, which means that a direction of the virtual object may be changed through the direction control, for example, turning left, turning right, or turning around.

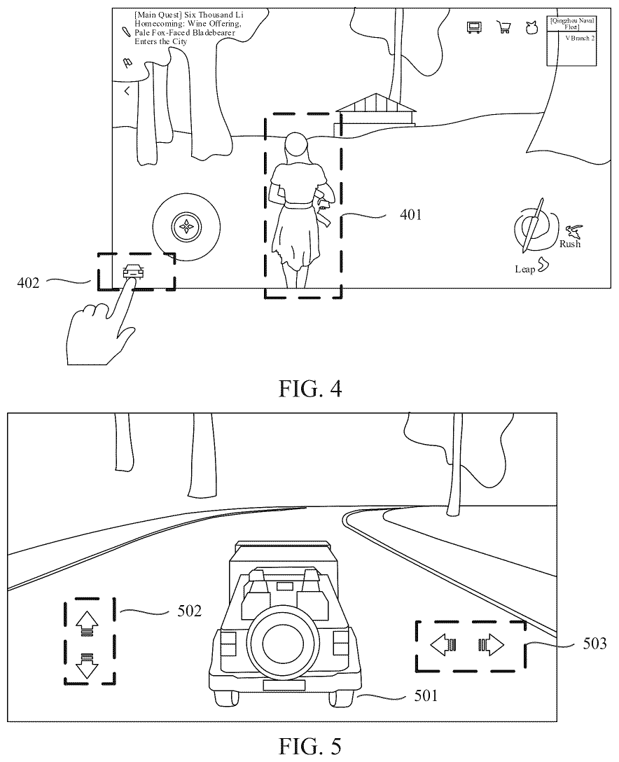

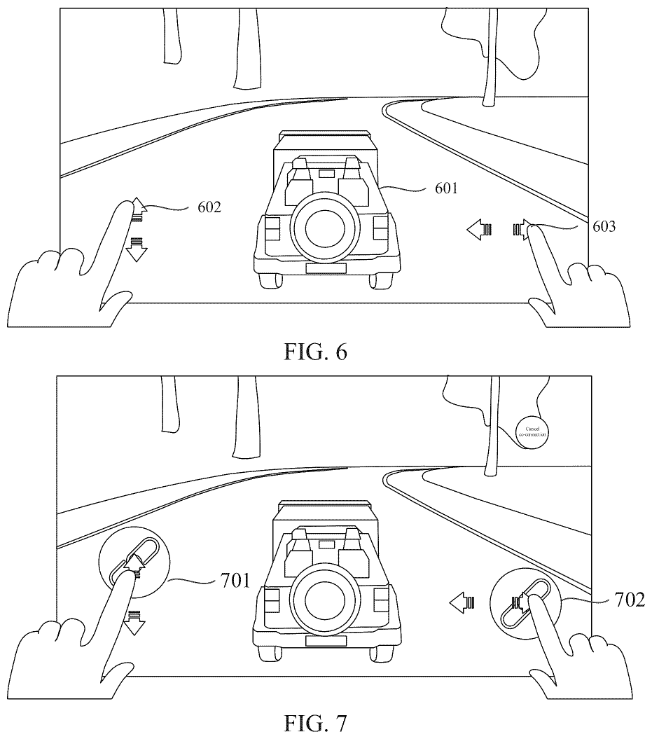

Exemplarily, a game scene is used as an example, FIG. 5 is a schematic diagram of a driving control and a direction control according to an embodiment of this application. Based on FIG. 5, in an interface of a virtual scene, a virtual object is a virtual vehicle, to be specific, an automobile. As shown in FIG. 5, the virtual vehicle “automobile” in a running state indicated by 501, a driving control indicated by a dashed-line box 502, and a direction control indicated by a dashed-line box 503 are presented.

Operation 102: Control, in response to a co-connection instruction for the driving control and the direction control, the driving control and the direction control to be in a co-connected state.

During actual implementation, in a process in which the terminal controls the virtual object to run or travel, after receiving the co-connection instruction for the driving control and the direction control, the terminal may control the driving control and the direction control to be in the co-connected state.

Next, a process of receiving the co-connection instruction for the driving control and the direction control is described.

In some embodiments, controlling, after the driving control and the direction control are displayed in response to a trigger operation performed simultaneously for the driving control and the direction control, the virtual object to simultaneously perform operations indicated by the driving control and the direction control, and obtaining an operation duration of the trigger operation; and triggering the co-connection instruction for the driving control and the direction control when the operation duration of the trigger operation reaches a duration threshold.

The trigger operation for the driving control and the direction control may be a pressing operation. An operation time difference for simultaneously indicating the trigger operation for the driving control and the trigger operation for the direction control herein is less than a preset duration threshold, such as 1 second.

During actual implementation, when the trigger operation performed simultaneously for the driving control and the direction control is received, the virtual object is controlled to simultaneously perform operations indicated by the driving control and the direction control. In other words, based on a direction indicated by the execution of the driving control and the direction control, the virtual object is controlled to make a turn while traveling. For example, when a trigger operation performed simultaneously for a forward button in the driving control and a right-turn button in the direction control is received, within the operation duration of the trigger operation, i.e., before the co-connection instruction for the driving control and the direction control is triggered, the virtual object is controlled to slightly turn right, i.e., travel to the right front while traveling forward. An angle at which the virtual object is controlled to make a turn based on the direction indicated by the execution of the driving control and the direction control is in positive correlation with a preset duration threshold. For example, when the duration threshold is 1 second, the angle at which the virtual object is controlled to make a turn based on the direction indicated by the execution of the driving control and the direction control is 10 degrees. When the duration threshold is 2 seconds, the angle at which the virtual object is controlled to make a turn based on the direction indicated by indicated by the execution of driving control and the direction control is 20 degrees.

Exemplarily, FIG. 6 is a schematic diagram of a trigger operation simultaneously performed in a driving control and a direction control according to an embodiment of this application. Based on FIG. 6, a pressing operation simultaneously performed on a forward button indicated by 602 in the driving control and a right-turn button indicated by 603 in the direction control is received, a virtual object indicated by 601 is controlled to turn right. When an operation duration of the trigger operation reaches a duration threshold, a co-connection instruction for the driving control and the direction control is triggered.

By applying the foregoing embodiment, when the trigger operation performed simultaneously for the driving control and the direction control is received, the virtual object is controlled to simultaneously perform the operations indicated by the driving control and the direction control. In other words, in a process of co-connecting the driving control and the direction control, a traveling state of the virtual object is not kept unchanged, thereby improving diversity of an interaction process in a virtual scene, and difficulty of co-connecting the driving control and the direction control by a user during the traveling.

In some other embodiments, keeping, after the driving control and the direction control are displayed in response to a trigger operation performed simultaneously for the driving control and the direction control, a current state of the virtual object unchanged, and obtaining an operation duration of the trigger operation; and triggering the co-connection instruction for the driving control and the direction control when the operation duration of the trigger operation reaches a duration threshold.

As described above, the trigger operation for the driving control and the direction control herein may be a pressing operation. An operation time difference for simultaneously indicating the trigger operation for the driving control and the trigger operation for the direction control herein is less than a preset duration threshold, such as 1 second.

During actual implementation, when the trigger operation performed simultaneously for the driving control and the direction control is received, the current state of the virtual object is kept unchanged. In other words, a current traveling state of the virtual object is kept unchanged. For example, the virtual object travels straight before the trigger operation performed simultaneously for the driving control and the direction control is received. In this case, the virtual object continues to be controlled to travel in a straight line when the trigger operation performed simultaneously for the driving control and the direction control is received. In other words, the current state of the virtual object is kept unchanged.

Exemplarily, still referring to FIG. 6, based on FIG. 6, the pressing operation simultaneously performed on the forward button in the driving control indicated by 602 and the right-turn button in the direction control indicated by 603 is received. The virtual object indicated by control 601 keeps a current traveling state unchanged, for example, continues to travel in a straight line. When the operation duration of a trigger operation reaches the duration threshold, the co-connection instruction for the driving control and the direction control is triggered.

During an actual application, when the trigger operation performed simultaneously for the driving control and the direction control is received, the current traveling state of the virtual object is kept unchanged. In other words, in a process of co-connecting the driving control and the direction control, that the traveling state of the virtual object is not changed is maintained, which reduces co-connection difficulty in a user traveling process, thereby improving human-computer interaction efficiency.

In some embodiments, the driving control includes a first driving sub-control configured to control the virtual object to travel forward and a second driving sub-control configured to control the virtual object to travel backward. The direction control includes a first direction sub-control configured to control the virtual object to turn left and a second direction sub-control configured to control the virtual object to turn right. Based on the above, when a co-connection instruction for the target driving sub-control and the target direction sub-control is received, a display style of the target driving sub-control and a display style of the target direction sub-control are switched from a default style to a target style. The target style is configured for distinguishing the target driving sub-control and the target direction sub-control from another driving sub-control and another direction sub-control. The target driving sub-control is one of the first driving sub-control and the second driving sub-control. The target direction sub-control is one of the first direction sub-control and the second direction sub-control. The another driving sub-control is a driving sub-control other than the target driving sub-control in the first driving sub-control and the second driving sub-control. The another direction sub-control is a direction sub-control other than the target direction sub-control in the first direction sub-control and the second direction sub-control.

For example, when the driving control targeted by the co-connection instruction is the first driving sub-control and the direction control targeted by the co-connection instruction is the first direction sub-control, in other words, when the target driving sub-control is the first driving control and the target direction sub-control is the first direction control, the display style of each of the first driving sub-control and the display style of the first direction sub-control is switched from the default style to the target style. The target style is configured for distinguishing the first driving sub-control and the first direction sub-control from the second driving sub-control and the second direction sub-control.

Alternatively, when the driving control targeted by the co-connection instruction is the second driving sub-control and the direction control targeted by the co-connection instruction is the second direction sub-control, in other words, when the target driving sub-control is the second driving control and the target direction sub-control is the second direction control, a display style of the second driving sub-control and a display style of the second direction sub-control are switched from the default style to the target style. The target style is configured for distinguishing the second driving sub-control and the second direction sub-control from the first driving sub-control and the first direction sub-control.

The first driving sub-control corresponding to forward and the second driving sub-control corresponding to backward included in the driving control are a forward button and a backward button in the foregoing driving control. The first direction sub-control corresponding to left turning and a second direction sub-control corresponding to right turning included in the direction control are a left-turn button and a right-turn button in the foregoing direction control. The target style herein may be preset, and the default style may be a style in which the driving control and the direction control are in a co-connected state.

Exemplarily, FIG. 7 is a schematic diagram of a first driving sub-control and a first direction sub-control in a target style according to an embodiment of this application. Based on FIG. 6 and FIG. 7, when a driving control for a co-connection instruction is a first driving sub-control indicated by 701 and a direction control for a co-connection instruction is a first direction sub-control indicated by 702, a display style of the first driving sub-control and a display style of the first direction sub-control are switched from default styles indicated by 602 and 603 in FIG. 6 to target style indicated by 701 and 702 in FIG. 7.

Applying the foregoing embodiment, a driving sub-control and a direction sub-control that are in a co-connected state are different from a driving sub-control and a direction sub-control that are not in a co-connected state through the target style, which not only facilitates perception by a user, but also improves hardware resource utilization of an electronic device.

Operation 103: Control, in response to a trigger operation for a target control, the virtual object to make a turn while traveling when the driving control and the direction control are in the co-connected state, the target control being at least one of the driving control and the direction control.

When the driving control and the direction control are in the co-connected state, in response to the trigger operation on the driving control or the direction control, the virtual object is controlled to make a turn while traveling. That being controlled to make a turn while traveling is turning direction, i.e., cornering, during the traveling.

During actual implementation, displaying, when the driving control and the direction control are in the co-connected state, a steering angle adjustment control in an associated area of the target control in response to the trigger operation for the target control; and adjusting, in response to a steering angle adjustment operation triggered based on the steering angle adjustment control during execution of the trigger operation, a steering angle of the virtual object during the traveling and steering of the virtual object.

The associated area of the target control may be any area with the target control as a center, for example, may be a circular area with a target control as a circle center and a target distance as a radius. The target distance herein may be preset, for example, 1 centimeter. In addition, because the target control includes at least one of the direction control and the driving control, when the target control is the direction control or the driving control, the steering angle adjustment control is directly displayed in the associated area of the target control if the trigger operation for the target control is received. When the target control is the direction control and the driving control, the steering angle adjustment control is displayed in the associated area of the direction control if the trigger operation for the target control is received.

In an actual application, after the direction control and the driving control are co-connected, the steering angle of the virtual object is adjusted through the steering angle adjustment control, which improves diversity of interaction processes in a virtual scene, and improves human-computer interaction efficiency and hardware resource utilization of the electronic device.

During actual implementation, the steering angle adjustment control displayed in the associated area of the target control may be in a draggable state, so that the steering angle of the virtual object is adjusted based on the dragging operation for the steering angle adjustment control during the traveling and steering of the virtual object. In other words, the draggable area corresponding to the steering angle adjustment control may be displayed. In response to the dragging operation performed on the steering angle adjustment control in the draggable area, the dragging operation is determined as the steering angle adjustment operation.

When the steering angle adjustment control displayed in the associated area of the target control is in the draggable state, the draggable area corresponding to the steering angle adjustment control may be the same area as the associated area displayed by the steering angle adjustment control, i.e., the associated area of the target control. Alternatively, the draggable area corresponding to the steering angle adjustment control is greater than the associated area displayed by the steering angle adjustment control, or the draggable area corresponding to the steering angle adjustment control is less than the associated area displayed by the steering angle adjustment control, which is not limited in this embodiment of this application. When the draggable area corresponding to the steering angle adjustment control may be the same area as the associated area displayed by the steering angle adjustment control, the dragging operation performed on the steering angle adjustment control in the draggable area is a dragging operation performed on the steering angle adjustment control in a range of the associated area.

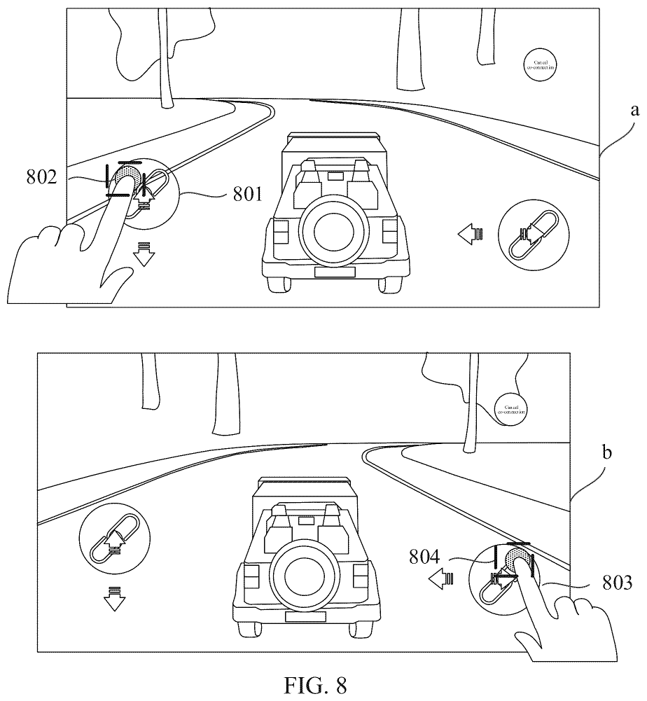

Exemplarily, FIG. 8 is a schematic diagram showing a steering angle adjustment control according to an embodiment of this application. Based on FIG. 8, when a driving control and a direction control are in a co-connected state, in response to a trigger operation for a driving control indicated by 801 in a, the driving control indicated by 801 is determined as a target control. A steering angle adjustment control indicated by a dashed-line box 802 is displayed in an associated area of the target control, i.e., a circular area indicated by 801. In this way, in response to a steering angle adjustment operation triggered based on the steering angle adjustment control indicated by the dashed-line box 802, a steering angle of the virtual object is adjusted during the traveling and steering of the virtual object.

Alternatively, in response to a trigger operation for a direction control indicated by 803 in b, the direction control indicated by 803 is determined as a target control. A steering angle adjustment control indicated by a dashed-line box 804 is displayed in an associated area of the target control, i.e., a circular area indicated by 803. In this way, in response to a steering angle adjustment operation triggered based on the steering angle adjustment control indicated by the dashed-line box 804, a steering angle of the virtual object is adjusted during the traveling and steering of the virtual object.

By applying the foregoing embodiment, a specific manner of the steering angle adjustment operation is clearly realized by limiting the draggable area. The steering angle adjustment operation is implemented through a dragging operation for the steering angle adjustment control. In this way, a user can adjust the steering angle of the object during the traveling, which improves human-computer interaction efficiency.

In some embodiments, the draggable area may be a circular area, so that during traveling and steering of the virtual object, a process of adjusting the steering angle of the virtual object may be obtaining a central angle formed by a position of the steering angle adjustment control after being dragged, a position of the steering angle adjustment control before being dragged, and a circle center position of the circular area, and adjusting the steering angle of the virtual object based on the central angle.

When the position of the steering angle adjustment control before being dragged is the circle center position of the circular area, a vertical line is draw relative to the circle center position. A central angle formed by the circle center position of the circular area, the position of the steering angle adjustment control after being dragged, and the vertical line is obtained, so as to adjust the steering angle of the virtual object based on the central angle. A process of adjusting the steering angle of the virtual object based on the circle central angle may be as follows. If the position of the steering angle adjustment control after being dragged is on a left side of a perpendicular bisector of a horizontal line on which the circle center position is located, the steering angle of the virtual object is adjusted to the left side by a degree corresponding to the central angle. If the position of the steering angle adjustment control after being dragged is on a right side of a perpendicular bisector of a horizontal line on which the circle center position is located, the steering angle of the virtual object is adjusted to the right side by a degree corresponding to the central angle.

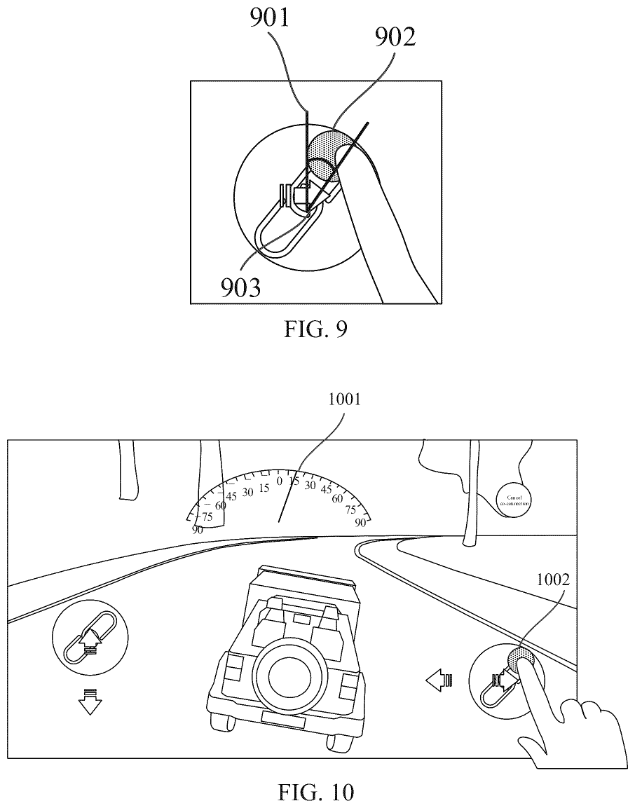

Exemplarily, FIG. 9 is a schematic diagram of determining a central angle based on a steering angle adjustment control according to an embodiment of this application. Based on FIG. 9, 901 indicates a vertical line relative to a circle center position. 902 indicates a steering angle adjustment control. A position of the steering angle adjustment control indicated by 902 is a position after the steering angle adjustment control is dragged. 903 indicates the position of the circle center position. Therefore, a central angle formed by the circle center position of the circular area indicated by 903, the position of the steering angle adjustment control indicated by 902 after being dragged, and the vertical line indicated by 901 is obtained, so as to adjust the steering angle of the virtual object based on the central angle.

During an actual application, the steering angle of the virtual object is adjusted based on the central angle formed by the position of the steering angle adjustment control after being dragged, the position of the steering angle adjustment control before being dragged, and the circle center position of the circular area, which reduces difficulty in a process of adjusting the steering angle of the virtual object.

In some embodiments, displaying an orientation pointer during the execution of the trigger operation, the orientation pointer being configured to indicate a current steering angle of the virtual object; and changing a position of the orientation pointer in response to the steering angle adjustment operation triggered based on the steering angle adjustment control, the changed position of the orientation pointer matching a steering angle of the virtual object after the steering angle is adjusted.

The orientation pointer is located on a pointer wheel on a virtual interface, and an angle formed by the orientation pointer and a vertical line of the pointer wheel is a current steering angle of the virtual object. When the current steering angle is equal to zero, the virtual object currently travels straight. When the current steering angle is greater than zero (i.e., the orientation pointer is on a right side of the vertical line of the pointer wheel), the virtual object currently turns right. When the current steering angle is less than zero (i.e., the orientation pointer is on a left side of the vertical line of the pointer wheel), the virtual object currently turns left.

In addition, the position of the orientation pointer and the steering angle of the virtual object also correspond in real time. For example, in response to an adjustment operation for turning right triggered based on the steering angle adjustment control, the position of the orientation pointer is rotated right. In other words, the virtual object is instructed to turn right. The changed position of the orientation pointer matches the steering angle of the virtual object after the steering angle is adjusted, and is configured for indicating that an angle formed by the changed position of the orientation pointer and the position of the orientation pointer before the change is consistent with the steering angle of the virtual object after the steering angle is adjusted.

Exemplarily, FIG. 10 is a schematic diagram of an orientation pointer according to an embodiment of this application. Based on FIG. 10, in response to a rightward turning adjustment operation triggered based on a steering angle adjustment control indicated by 1002, a position of the orientation pointer indicated by 1001 turns right. In other words, a virtual object is instructed to turn right by 15 degrees.

By applying the foregoing embodiment, the displayed orientation pointer enables a user to clarify a current running angle, which improves traveling experience of the user in a virtual scene, help the user determine whether to adjust the steering angle, and avoid a case in which the user unconsciously adjusts the steering angle, thereby improving human- computer angle efficiency and hardware resource utilization of an electronic device.

In some embodiments, a process of adjusting the steering angle of the virtual object during the traveling and steering of the virtual object may be: obtaining a current steering angle of the virtual object during the traveling; performing summation on the current steering angle and the steering angle indicated by the steering angle adjustment operation when a direction corresponding to the current steering angle is the same as a direction indicated by the steering angle adjustment operation, to obtain a target steering angle; performing differencing on the current steering angle and the steering angle indicated by the steering angle adjustment operation when the direction corresponding to the current steering angle is opposite to the direction indicated by the steering angle adjustment operation, to obtain a target steering angle; and adjusting the steering angle of the virtual object to the target steering angle.

The direction corresponding to the current steering angle is indicated in a same direction as the direction indicated by the steering angle adjustment operation. When the virtual object turns left during the traveling, the virtual object is controlled to turn left in response to the steering angle adjustment operation, or when the virtual object turns right during the traveling, the virtual object is controlled to turn right in response to the steering angle adjustment operation. The direction corresponding to the current steering angle is indicated in an opposite direction to the direction indicated by the steering angle adjustment operation. When the virtual object turns left during the traveling, in response to the steering angle adjustment operation, the virtual object is controlled to turn right or when the virtual object turns right during the traveling, in response to the steering angle adjustment operation, the virtual object is controlled to turn left.

As described above, the steering angle adjustment operation may be a dragging operation performed on the steering angle adjustment control in the draggable area. When the dragged position of the steering angle adjustment control is on the right of a vertical line relative to a horizontal line of the circle center position, and the virtual object turns right during the traveling, if a direction corresponding to the current steering angle is in a same direction as a direction indicated by the steering angle adjustment operation, summation processing is performed on the current steering angle and the steering angle indicated by the steering angle adjustment operation, to obtain a target steering angle.

When the position at which the steering angle adjustment control is dragged is to the left of the vertical line relative to the horizontal line at which the circle center position is located, and the virtual object turns right during the traveling, if a direction corresponding to the current steering angle is opposite to a direction indicated by the steering angle adjustment operation, differencing is performed on the current steering angle and the steering angle indicated by the steering angle adjustment operation, to obtain the target steering angle.

During actual implementation, the steering angle (for example, a current steering angle or a steering angle indicated by a steering angle adjustment operation) in this application includes a steering angle to left and a steering angle to right. When the virtual object travels straight, the steering angle is zero, when the virtual object turns right, the steering angle is greater than zero, and when the virtual object turns left, the steering angle is less than zero.

Based on this, because the steering angle less than zero exists, when the direction corresponding to the current steering angle is the same as the direction indicated by the steering angle adjustment operation, performing summation processing on the current steering angle and the steering angle indicated by the steering angle adjustment operation instructs to perform summation processing on absolute values of the current steering angle and the steering angle indicated by the steering angle adjustment operation. When the direction corresponding to the current steering angle is opposite to the direction indicated by the steering angle adjustment operation, performing differencing between the current steering angle and the steering angle indicated by the steering angle adjustment operation instructs to perform differencing between absolute values of the current steering angle and the steering angle indicated by the steering angle adjustment operation.

If the direction corresponding to the current steering angle is in the same direction with the direction indicated by the steering angle adjustment operation, the steering angle of the virtual object is directly adjusted to the target steering angle obtained through summation based on the direction corresponding to the current steering angle or the direction indicated by the steering angle adjustment operation. If the direction corresponding to the current steering angle is opposite to the direction indicated by the steering angle adjustment operation, the absolute values of the current steering angle and the steering angle of the virtual object indicated by the steering angle adjustment operation are obtained. Finally, the turning direction of the virtual object corresponds to a direction indicated by a larger absolute value. Based on the above, the steering angle of the virtual object is adjusted, based on the direction indicated by the one having a larger absolute value, to the target steering angle obtained through performing difference.

The target steering angle herein is greater than zero, and the target steering angle only indicates a magnitude of the adjusted angle, and does not indicate a direction. The absolute value of the current steering angle is compared with the absolute value of the steering angle of the virtual object indicated by the steering angle adjustment operation. If a direction indicated by the one having a larger absolute value is the left side of the vertical line relative to the horizontal line of the circle center position, an opposite number of the target steering angle is obtained, and the opposite number is determined as the adjusted steering angle of the virtual object. In other words, the adjusted steering angle of the virtual object is less than zero. If the direction indicated by the one having a larger absolute value is on a right side of the vertical line relative to the horizontal line of the circle center position, the target steering angle obtained through final adjustment is directly used as the adjusted steering angle of the virtual object. In other words, the adjusted steering angle of the virtual object is greater than zero.

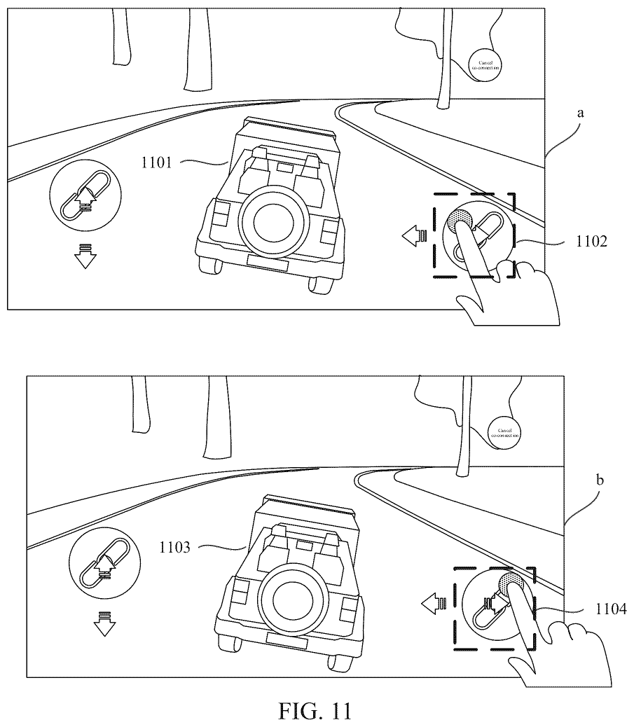

Exemplarily, FIG. 11 is a schematic diagram of adjusting a steering angle of a virtual object according to an embodiment of this application. Based on FIG. 11, a direction (turning right) corresponding to a current steering angle in a is opposite to a direction (turning left) indicated by a steering angle adjustment operation indicated by a dashed-line box 1102. Differencing is performed on an absolute value of the current steering angle, for example, 15 degrees, and an absolute value of a steering angle, for example, −30 degrees, indicated by the steering angle adjustment operation, to obtain a target steering angle, to be specific, 15 degrees. Based on a direction indicated by a larger absolute value, i.e., turning left, a steering angle of the virtual object indicated by 1101 is adjusted to the target steering angle of 15 degrees obtained by difference. In other words, the steering angle of the virtual object is adjusted to turn left by 15 degrees.

Alternatively, the direction (turning right) corresponding to the current steering angle in a is in the same direction as the direction (turning right) indicated by the steering angle adjustment operation indicated by the dashed-line box 1104. Differencing is performed on the absolute value of the current steering angle, for example, 15 degrees, and the absolute value of the steering angle indicated by the steering angle adjustment operation, for example, 30 degrees, to obtain a target steering angle, i.e., 45 degrees. The steering angle of the virtual object indicated by 1103 is adjusted based on the direction corresponding to the current steering angle or the direction indicated by the steering angle adjustment operation, namely, turning right, to the target steering angle of 45 degrees. In other words, the steering angle of the virtual object is adjusted to turning right by 45 degrees.

In some embodiments, in response to a steering angle adjustment operation triggered by a steering angle adjustment control, after the steering angle of the virtual object is adjusted during traveling and steering of the virtual object, a quantity of steering angle adjustment operations performed on the virtual object may be further obtained. Automatically adjusting the steering angle of the virtual object to a standard steering angle when the quantity of operations reaches a threshold quantity of times, the standard steering angle being configured for indicating a steering angle at which the virtual object is able to drive through a turn on a current road turn line.

The standard steering angle may indicate an angle range, and angles included in the angle range all enable the virtual object to drive through a turn on a current road turn line. For example, when the adjusted current steering angle of the virtual object during the traveling is a rightward steering angle, i.e., 15 degrees and an angle range indicated by the standard steering angle by which the virtual object can drive through a turn on the current road turn line is [10, 15], the adjusted steering angle of the virtual object is within the angle range. In other words, the virtual object can drive through a turn on a current road turn line.

During the traveling and steering of the virtual object, after the steering angle of the virtual object is adjusted, the steering angle of the virtual object may be automatically adjusted based on a relationship between the quantity of operations of the steering angle adjustment operation performed on the virtual object and the threshold quantity of times. The terminal obtains the quantity of operations of the steering angle adjustment operation performed on the virtual object within a preset time period, and compares a historical adjustment quantity with the threshold quantity of times. When the quantity of operations reaches a preset threshold quantity of times, the terminal automatically adjusts the steering angle of the virtual object. The threshold quantity of times may be preset, for example, may be 10 times. The preset time period is also preset, for example, may be 3 minutes, which is not limited in this embodiment of this application.

In an actual application, when the user performs adjustment for an excessively large quantity of times, an adjustment threshold quantity of times is set to automatically adjust the steering angle of the virtual object, which reduces difficulty in a user interaction process and avoids frequent adjustment performed by the user, thereby improving human- computer interaction efficiency and hardware resource utilization of an electronic device.

For a game in which the steering angle adjustment operation is a leading behavior, to ensure fair and reasonableness of the game, a terminal automatically adjusts the steering angle of the virtual object under a condition. For example, an automatic adjustment quantity corresponding to a level of a player is allocated to the player for free, or an adjustment quantity for paid purchase of a toy.

In some embodiments, during the traveling and steering of the virtual objects, a guide line corresponding to the virtual object is further displayed, the guide line being configured for indicating an actual traveling direction of the virtual object in the virtual scene.

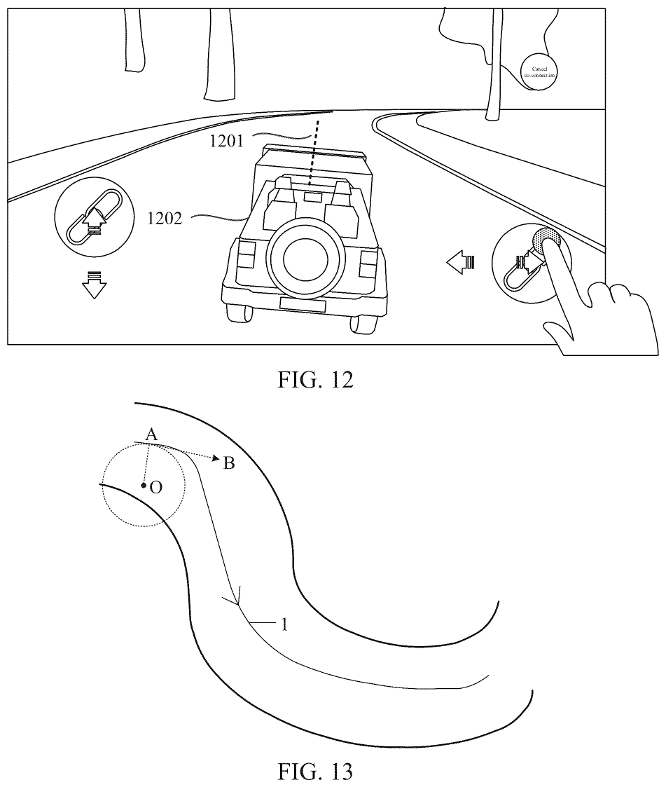

The guide line is displayed in front of the virtual object. For example, when the virtual object is a virtual automobile, the guide line is displayed right in front of a middle position of tan automobile body. When the virtual object is a player character, the guide line is displayed right in front of under-foot of a middle position of the player. In addition, a form of the guide line may be preset, for example, may be a laser lead. Exemplarily, FIG. 12 is a schematic diagram of a guide line according to an embodiment of this application. Based on FIG. 12, when a virtual object is a virtual automobile indicated by 1202, the guide line indicated by 1201 is displayed right in front of a middle position of an automobile body.

By applying the foregoing embodiments, an actual traveling direction of the virtual object is displayed based on the guide line, so that the user can adjust a direction of the virtual object, which improves diversity of an interaction process in a virtual scene, human computer interaction efficiency, and hardware resource utilization of an electronic device.

During actual implementation, in a process in which a virtual object travels and turns, a process of displaying the guide line corresponding to the virtual object may be: generating, based on a real-time position of the virtual object on a current road during the traveling and steering of the virtual object, a curvature circle corresponding to the real-time position; and generating a tangent line with the real-time position as a tangent point based on the curvature circle, and displaying the guide line corresponding to the virtual object based on the tangent line.

During the traveling and steering of the virtual object, a real-time position of the virtual object changes. Therefore, the curvature circle corresponding to the real-time position also changes accordingly. In this way, a tangent line that uses the real-time position as a tangent point, i.e., the guide line corresponding to the virtual object, also changes in real time based on the curvature circle. The current road may be a straight road, or a curved road, which is not limited in this embodiment of this application. The curvature circle corresponding to the real-time position determined based on the real-time position of the virtual object on the current road is determined with reference to a speed direction of the virtual object. Therefore, for the same position, if the speed direction is different, the corresponding curvature circle is also different. The direction of the guide line corresponding to the virtual object also corresponds to the speed direction of the virtual object. In other words, the speed direction of the virtual object may be directly obtained, so that the guide line corresponding to the virtual object is determined based on the speed direction of the virtual object.

Exemplarily, FIG. 13 is a schematic diagram of a process for determining a guide line corresponding to a virtual object according to an embodiment of this application. Based on FIG. 13, number 1 in FIG. 13 shows a traveling path of the virtual object. A is a current real-time position of the virtual object, and a circle O is a curvature circle corresponding to the real-time position. Therefore, based on the circle O, a tangent line AB that uses the real-time position A as a tangent point is determined, i.e., the guide line corresponding to the virtual object.

During an actual application, the guide line corresponding to the virtual object is determined through the curvature circle corresponding to the real-time position of the virtual object, which ensures accuracy of the guide line configured for indicating an actual traveling direction of the virtual object, thereby improving human-computer interaction efficiency and hardware resource utilization of an electronic device.

In some embodiments, during the traveling and steering of the virtual object, first prompt information is displayed when the current steering angle of the virtual object during the traveling is consistent with the standard steering angle indicating that the virtual object can drive through a turn on a current road turn line, the first prompt information being configured for indicating that the virtual object successfully makes a turn during the traveling.

The first prompt information may be displayed when the virtual object turns when a bending line occurs in the road. The virtual object can successfully turn during the traveling, to indicate that the virtual object can travel safely without colliding with a surrounding object. For example, when the virtual object travels on a straight road, an obstacle appears in front, and the virtual object may avoid the obstacle by turning. In this case, for a standard steering angle at which the virtual object can drive through a turn on a current road turn line, the current road turn line may be a current traveling bending line path of the virtual object. The standard steering angle may be considered as a steering angle at which the virtual object can evade the obstacle, i.e., a steering angle at which the virtual object can drive through a turn on the current road turn line. When the virtual object travels on a curved road, the standard steering angle is a steering angle at which the virtual object can drive through a turn on a current road turn line without colliding with a surrounding object. The standard steering angles appearing in the foregoing and the following may be considered in this way. Details are not described in the embodiments of this application.

In addition, the first prompt information is preset and may be text information, image information, animation information, or the like. When the first prompt information is the text information, text content may be “turning succeeds”. When the first prompt information is the image information, the image may be an image identifier of a logged sign, for example, “√”.

As described above, the standard steering angle indicates an angle range. The current steering angle of the virtual object during the traveling is consistent with the standard steering angle at which the virtual object can drive through a turn on the current road turn line, which means that the current steering angle of the virtual object is within the angle range indicated by the standard steering angle. For example, when the current steering angle of the virtual object during the traveling is a rightward steering angle, i.e., 15 degrees, and the angle range indicated by the standard steering angle at which the virtual object can drive through a turn on the current road turn line is [10, 15], the steering angle of the virtual object is within the angle range. In other words, the current steering angle of the virtual object during the traveling is consistent with the standard steering angle at which the virtual object can drive through a turn on the current road turn line.

Correspondingly, when the current steering angle of the virtual object during the traveling is a rightward steering angle, i.e., 20 degrees, and an angle range indicated by the standard steering angle by which the virtual object can drive through a turn on the current road turn line is [10, 15], the steering angle of the virtual object does not fall within the angle range. In other words, the current steering angle of the virtual object during the traveling is not the same as the standard steering angle by which the virtual object can drive through a turn on the current road turn line.

By applying the foregoing embodiment, whether the first prompt information configured for indicating that the virtual object can successfully turn during the traveling is displayed, to remind the user of whether the virtual object can successfully turn, so that the user can adjust the steering angle in time, thereby improving human-computer interaction efficiency and hardware resource utilization of the electronic device.

During actual implementation, during the traveling and steering of the virtual object, the guide line and the orientation pointer may further be displayed. As described above, the guide line is configured for indicating an actual traveling direction of the virtual object in the virtual scene, and the orientation pointer is configured to indicate a current steering angle of the virtual object. Therefore, a process of displaying the first prompt information may be: displaying the first prompt information at an associated position of the orientation pointer when the steering angle corresponding to the actual traveling direction indicated by the guide line and/or the current steering angle of the virtual object indicated by the orientation pointer are consistent with a standard steering angle indicating that the virtual object can drive through a turn on a current road turn line.

The associated position may be one of an upper position, a lower position, a left position, or a right position of the orientation pointer. Being consistent means that the current steering angle of the virtual object falls within the angle range indicated by the standard steering angle. For example, when the current steering angle of the virtual object during the traveling is the rightward steering angle, i.e., 15 degrees, and an angle range indicated by the standard steering angle by which the virtual object can drive through a turn on a current road turn line is [10, 15], the steering angle of the virtual object falls within the angle range. In other words, the current steering angle of the virtual object during the traveling is consistent with the standard steering angle by which the virtual object can drive through a turn on the current road turn line. Correspondingly, when the current steering angle of the virtual object during the traveling is a rightward steering angle, i.e., 20 degrees, and an angle range indicated by the standard steering angle by which the virtual object can drive through a turn on the current road turn line is [10, 15], the steering angle of the virtual object does not fall within the angle range. In other words, the current steering angle of the virtual object during the traveling is not the same as the standard steering angle by which the virtual object can drive through a turn on the current road turn line.

Exemplarily, FIG. 14 is a schematic diagram of first prompt information according to an embodiment of this application. Based on FIG. 14, during the traveling and steering of the virtual object indicated by 1404, a guide line indicated by 1401 and an orientation pointer indicated by 1402 are displayed. When a steering angle corresponding to the actual traveling direction indicated by the guide line is consistent with a standard steering angle at which the virtual object can drive through a turn on a current road turn line, first prompt information indicated by 1403 is displayed at an upper position of the orientation pointer.

In some embodiments, displaying, during the traveling and steering of the virtual object, an automatic adjustment control when the current steering angle of the virtual object during the traveling is inconsistent with the standard steering angle indicating that the virtual object is able to drive through a turn on the current road turn line, the automatic adjustment control being configured to automatically adjust the steering angle of the virtual object during the traveling; and automatically adjusting the steering angle of the virtual object during the traveling in response to a trigger operation for the automatic adjustment control.

The automatic adjustment control is different from the direction control and the driving control, and may be an independently displayed control, so as to automatically adjust, in response to the trigger operation for the automatic adjustment control, the steering angle of the virtual object during the traveling. In an actual application, in this application, the process of automatically adjusting the steering angle of the virtual object during the traveling may include: first obtaining a standard steering angle at which the virtual object can drive through a turn on a current road turn line, and then adjusting the current steering angle of the virtual object during the traveling to the standard steering angle, so that the adjusted current steering angle of the virtual object during the traveling is consistent with the standard steering angle at which the virtual object can drive through a turn on the current road turn line. The consistency herein is as described above. Details are not described in this embodiment of this application again.

In an actual application, the user is helped to automatically adjust the steering angle of the virtual object during the traveling through the automatic adjustment control, which avoids a case in which the user frequently adjusts the steering angle, thereby improving human-computer angle efficiency and hardware resource utilization of the electronic device.

In some embodiments, a traveling state of the virtual object may further be detected. Obtaining, during the traveling and steering of the virtual object when a direction adjustment operation for the virtual object triggered based on the target control is received, a steering angle indicated by the direction adjustment operation; performing, when a direction corresponding to the steering angle indicated by the direction adjustment operation is the same as a direction indicated by the current steering angle of the virtual object, differencing on the direction corresponding to the steering angle indicated by the direction adjustment operation and the direction indicated by the current steering angle of the virtual object, to obtain a reference steering angle; performing, when a direction corresponding to the steering angle indicated by the direction adjustment operation is the same as a direction indicated by the current steering angle of the virtual object, differencing on the direction corresponding to the steering angle indicated by the direction adjustment operation and the direction indicated by the current steering angle of the virtual object, to obtain a reference steering angle; and displaying danger prompt information when the reference steering angle is greater than a reference steering angle threshold, the danger prompt information being configured for indicating that the virtual object is currently in a dangerous state. The dangerous state is configured for indicating that the virtual object may take a sharp corner.

Because the steering angle indicated by the direction adjustment operation is determined at an instant when the user performs the direction adjustment operation, instantaneity exists. When the direction adjustment operation for the virtual object triggered based on the driving control or the direction control is received, the current steering angle of the virtual object is not immediately changed based on the steering angle indicated by the direction adjustment operation. Therefore, when the direction adjustment operation for the virtual object triggered based on the driving control or the direction control is received, it may be predicted whether it is dangerous to control, based on the direction adjustment operation, the virtual object to make a turn during traveling.

In addition, as described above, based on a left-right difference, the steering angle and the current steering angle may be less than zero. When the direction corresponding to the steering angle indicated by the direction adjustment operation is in the same direction as the direction indicated by the current steering angle of the virtual object, differencing is performed on the direction corresponding to the steering angle indicated by the direction adjustment operation and the direction indicated by the current steering angle of the virtual object, to obtain a reference steering angle. In other words, differencing is performed on an absolute value of the steering angle and an absolute value of the current steering angle, and an absolute value of a difference result is used as the reference steering angle.

When the direction corresponding to the steering angle indicated by the direction adjustment operation is opposite to the direction indicated by the current steering angle of the virtual object, summation processing is performed on the direction corresponding to the steering angle indicated by the direction adjustment operation and the direction indicated by the current steering angle of the virtual object, to obtain the reference steering angle. In other words, summation is performed on the absolute value of the steering angle and the absolute value of the current steering angle, and a summation result is used as the reference steering angle. The reference steering angle threshold may be preset, for example, 60 degrees.

During actual implementation, the danger prompt information may be text information, image information, animation information, or the like. For example, when the danger prompt information is the text information, text content may be “danger”. When the danger prompt information is the image information, image content may be a red exclamation mark.

By applying the foregoing embodiment, the virtual object is warned when the virtual object travels and turns through the danger prompt information, which helps the user to re-adjust the steering angle of the virtual object during the traveling, improves human-computer angle efficiency and hardware resource utilization of the electronic device, and improves safety in the process of controlling the virtual object.

In some embodiments, when the absolute value of the reference steering angle difference is not greater than the reference steering angle threshold, safety prompt information may further be displayed. The safety prompt information is configured for indicating that the virtual object is currently in a safe state, i.e., a normal cornering state. Similarly, the safety prompt information may be the text information, the image information, the animation information, or the like. For example, when the safety prompt information is the text information, the text content may be “safety ahead”, and when the safety prompt information is the image information, the image content may be a smiling face.

In some embodiments, displaying a state switching control when the driving control and the direction control are in the co-connected state; controlling, in response to a trigger operation for the state switching control, the driving control and the direction control to switch from the co-connected state to a non-co-connected state; and controlling, in response to a trigger operation for a control of at least one of the driving control and the direction control, the virtual object to perform the operation indicated by the control triggered by the trigger operation when the driving control and the direction control are in the non-co- connected state.

In a case that the driving control and the direction control are in the non-co-connected state, in response to the trigger operation for the driving control, the virtual object is controlled to travel in a straight line when the virtual object travels straight. When the virtual object makes a turn, the virtual object is controlled to travel in response to the trigger operation for the direction control. When the virtual object makes a turn while traveling, in response to the trigger operation for the driving control and the direction control, the virtual object is controlled to make a turn while traveling.

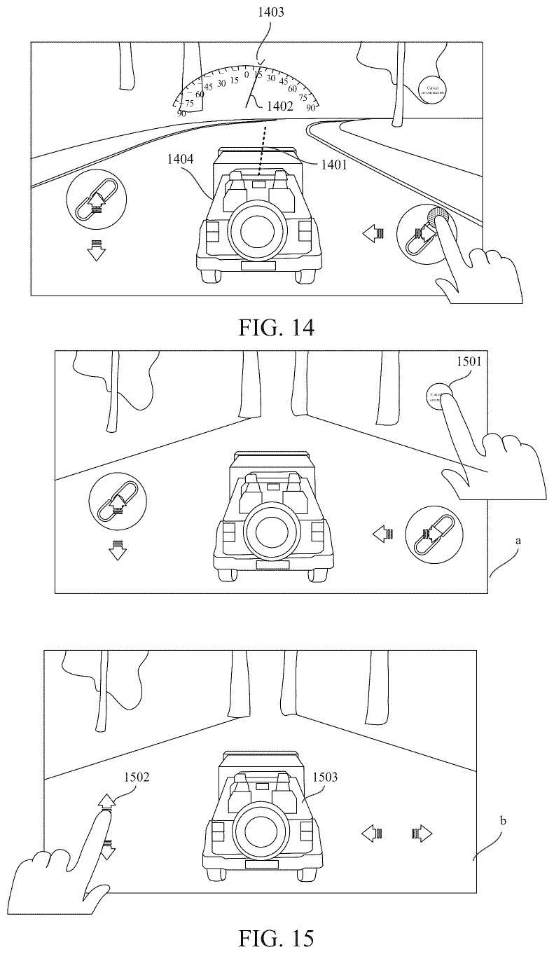

Exemplarily, FIG. 15 is a schematic diagram of a state switching control according to an embodiment of this application. When a driving control and a direction control are in a co-connected state based on a of FIG. 15, a state switching control indicated by 1501 may further be displayed. In response to the trigger operation for the state switching control indicated by 1501, the driving control and the direction control are controlled to be switched from being in the co-connected state to being in a non-co-connected state as shown in b. In this way, when the driving control and the direction control are in the non-co-connected state, in response to a trigger operation for the driving control indicated by 1502, the virtual object is controlled to travel in a straight line when the virtual object indicated by 1503 travels straight.

In an actual application, the state switching control helps the user to quickly switch the driving control and the direction control from being in the co-connected state to being in the non-co-connected state, which not only improves effectiveness and convenience of an interaction operation performed by the user, but also improves diversity of an interaction process, human computer interaction efficiency, and hardware resource utilization of an electronic device.

In some embodiments, a quantity of co-connections between the driving control and the direction control may be further limited. The process of controlling, in response to the co-connection instruction for the driving control and the direction control, the driving control and the direction control to be in a co-connected state may be: obtaining a quantity of co-connections between the driving control and the direction control within a target time period in response to the co-connection instruction for the driving control and the direction control; and controlling the driving control and the direction control to be in the co-connected state when the quantity of co-connections indicates that the quantity of co-connections between the driving control and the direction control does not reach a threshold quantity of times within the target time period.

The threshold quantity of times may be preset, for example, may be twenty. The target time period may also be preset, for example, may be six hours, which is not limited in this embodiment of this application. In this way, only when the quantity of co-connections does not exceed the threshold quantity of times, the driving control and the direction control can be co-connected. By limiting the quantity of co-connections, balance of an interaction process in the virtual scene is ensured.

In some embodiments, the virtual scene further includes a first virtual space and a second virtual space. Therefore, the process of displaying the first virtual object in the virtual scene may be displaying, in the second virtual space of the virtual scene, the virtual object transmitted from the first virtual space to the second virtual space of the virtual scene. In response to the trigger operation for the target control, after turning is performed while the virtual object is controlled to travel, the virtual object may be transmitted back to the first virtual space when the virtual object ends the traveling process in the second virtual space.

That the virtual object ends the traveling process in the second virtual space may be that the virtual object reaches a traveling end point, completes the traveling task, and has a traveling result. The first virtual space and the second virtual space are both preset and belong to the same virtual scene. The first virtual space and the second virtual space may be set to virtual spaces such as a desert, an ocean, a castle, or a jungle, which is not limited in this embodiment of this application.

By applying the foregoing embodiment of this application, in response to a co-connection instruction for a driving control configured to control the virtual object to travel forward or backward and a direction control configured to control the virtual object to turn left or turn right, the driving control and the direction control are controlled to be in the co-connected state. In this way, when the driving control and the direction control are in the co-connected state, in response to the trigger operation for at least one of the driving control and the direction control, the virtual object is controlled to make a turn while traveling. In this way, compared with the manner in the related art in which the driving control and the direction control need to be repeatedly clicked/tapped to adjust the steering process, the driving control and the direction control are controlled to be in the co-connected state, so that only the driving control or the direction control is triggered to implement an effect of controlling the virtual object to make a turn while traveling, thereby improving convenience and effectiveness of the interactive operation, reducing a quantity of adjustment operations performed by the user in the steering process, and improving human-machine interaction efficiency and increasing a utilization rate of hardware resources of the electronic device.

Next, an exemplary application of this embodiment of this application in an actual application scene is to be described.

With development of technologies and improvement of performance of mobile devices, an operation direction of a human-computer interface is inevitably to develop more convenient and more efficient control manners, so that a user has the more pleasant human-computer interaction manner. Therefore, this application provides a solution of easily turning a vehicle in a game. For example, if a player drives a vehicle to corner in a mobile game, the player usually presses a left hand to travel forward, and presses a right hand to turn, the player cannot smoothly corner. However, in this application, when the player drives the vehicle to corner, the player may perform an interactive operation change on a skill, to implement a turning operation with one hand, so that the operation is quick, convenient, and has better user experience.

Next, the technical solution of this application is described from a product side. First, as shown in FIG. 4, a player character controlled by a user account that currently logs in to an APP and a vehicle control are displayed in the virtual scene, so that the player character is controlled to enter the virtual vehicle in response to the trigger operation for the vehicle control. In other words, the player character is controlled to be in a vehicle driving mode. Then, as shown in FIG. 5, the driving control is operated with a left hand, i.e., a forward button and a backward button, and the direction control is operated with a right hand, i.e., a left-turn button or right-turn button. Then, as shown in FIG. 6 and FIG. 7, when a road is on a right turn, the player may simultaneously press the left hand in advance and press the right turn key on the right hand, so that the forward button and the right-turn button are triggered to form the co-connected state. Then, as shown in FIG. 8, in the co-connected state, a single-hand operation on the left hand or a single-hand operation on the right hand may control turning of the virtual vehicle. For example, when the forward button and the right-turn button are in the co-connected state, in response to the trigger operation for the forward button, the virtual vehicle may be controlled to turn right while moving forward, or in response to the trigger operation for the right-turn button, the virtual vehicle may be controlled to turn right while moving forward.

During actual implementation, as shown in FIG. 10, in the co-connected state, an orientation pointer in a virtual direction appears on a screen, and a pointer angle corresponds to a steering angle of a button operated by a finger of the player. In addition, as shown in FIG. 12, in the co-connected state, the vehicle also triggers a road curvature prompt, i.e., displays a laser lead (a guide line) for indicating an actual traveling direction of the vehicle. Moreover, as shown in FIG. 14, in the co-connected state, the player performs steering with one hand, so that when angles of the orientation pointer and the laser lead on the screen are approximately consistent with an angle for turning on a road turn line in an actual scene, a prompt identifier (first prompt information) indicating that turning is allowed appears. The turning may be perfectly implemented when the current angle is maintained. If the identifier does not appear, the player needs to adjust the angle of the control.

Finally, after the virtual vehicle successfully makes a turn, as shown in FIG. 15, in response to a trigger operation on a control (a state switching control) configured to cancel the co-connection, the driving control and the direction control are controlled to switch from the co-connected state to a non-co-connected state, i.e., a normal state, and in response to a trigger operation on the driving control indicated by 1502, the virtual object is controlled to travel in a straight line.

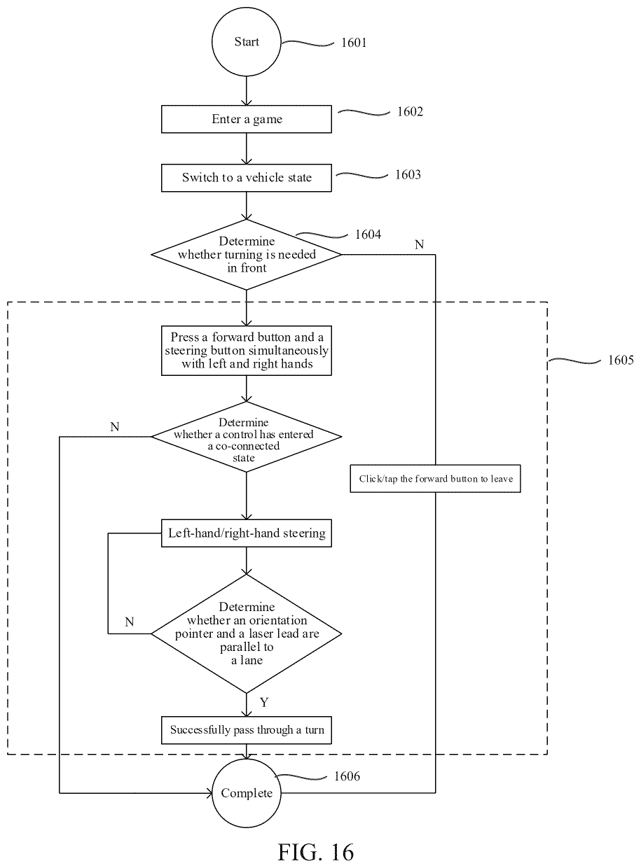

Next, the technical solution of this application is described from a technical perspective. FIG. 16 is a flowchart of a process of convenient turning of a vehicle in a game according to an embodiment of this application. Based on FIG. 16, operations 1601 to 1606 are provided for implementation in this application. After a player enters a game, a detection as to whether a player character controlled by a user enters a vehicle driving state is performed. In response to a clicking/tapping operation performed by the player on a “Board” button (a vehicle control), a carrier of the character is switched from the ground to a drivable vehicle (the drivable vehicle is referred to as a car for short below). A detection as to whether a current carrier of the character is a car is performed per frame, so that it may be determined that the player has entered a vehicle driving mode. In the driving mode, an interface interaction button is switched to “Exit”, and the player may exit the driving mode by clicking/tapping the “Exit” button. In this case, the interaction button enters a normal mode. After the player enters a vehicle state, a driving control that controls forward and backward driving forces and a direction control that controls left and right directions are controlled independently. To be specific, a left-hand button controls forward and backward driving, and a right-hand button controls left and right directions. Such a control mode is an independent control mode. In this case, when the player enters the vehicle, an independent control mode is entered by default. When a bend exists in front, it is determined whether turning is needed in front, namely, whether steering is needed. If the turning is not needed, a clicking/tapping operation on a driving control such as a forward button continues to be performed, to control the vehicle to travel in a straight line. If the turning is needed in the front, a hybrid control is performed on the driving control and the direction control to implement cornering. In this application, in the independent control mode, if a touch and hold operation is performed on both the driving control and the direction control, a co-connection control mode is entered. For example, if a pressing operation on a forward button in the driving control and a right-turn button in the direction control is performed, and the pressing operation is maintained for three seconds, a co-connection control mode is entered. In the co-connection control mode, a trigger operation is performed on one of the driving control or the direction control that is in a co-connected state, so that steering of the vehicle may be controlled. For example, when the forward button and the right-turn button are in a co-connected state, in response to a trigger operation for the forward button, the virtual vehicle may be controlled to turn right while moving forward, or in response to a trigger operation for the right-turn button, the virtual vehicle may be controlled to turn right while moving forward. In addition, during control of steering of the vehicle, it is determined, through the displayed laser lead and the orientation pointer configured to indicate an actual traveling direction of the vehicle, whether the vehicle can successfully corner. When the laser lead and the orientation pointer are parallel to a lane at all times, the vehicle can successfully corner. Moreover, in the co-connection control mode, a button to cancel the co-connection is further displayed. In this way, when the controls do not need to be in the co-connected state, in response to the clicking/tapping operation on the button to cancel the co-connection, the independent control mode is entered.

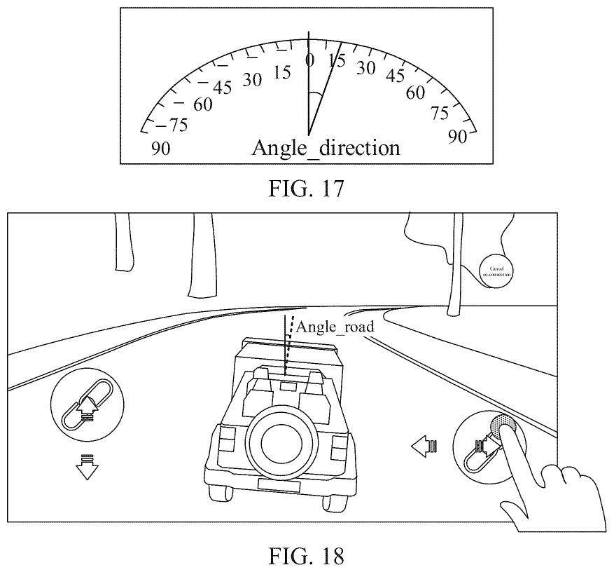

As shown in FIG. 17, FIG. 17 is a schematic diagram of a current steering angle of a vehicle according to an embodiment of this application. Based on FIG. 17, in a co-connection control mode, a front wheel rotation angle pointer wheel is displayed right above an interface. An angle value is a current steering angle of the vehicle. When an angle value >0, the vehicle is turning right, and when an angle value <0, the vehicle is turning left.

In some embodiments, in a co-connection mode, the driving control and the direction control may independently control a direction of the vehicle, or may simultaneously control a direction of the vehicle. A steering angle indicated by the driving control is referred to as Angle_L, and a steering angle indicated by the direction control is referred to as Angle_R. Based on this, the actual traveling direction of the vehicle, i.e., the current steering angle of the vehicle, is Angle_direction=Angle_R+Angle_L. In other words, a final wheel direction is a sum of steering angles indicated by the driving control and the direction control.

Exemplarily, when the direction control independently controls a direction of the vehicle, Angle_direction=Angle_R. In other words, the steering angle is determined with one hand on the right. When the driving control independently controls the direction of the vehicle, Angle_direction=Angle_L. In other words, the steering angle is determined with one hand on the right. When the driving control and the direction control simultaneously control the direction of the vehicle, if left and right directions are the same, steering angles indicated by the two controls are superimposed, to cause a steering amplitude to be larger, for example, Angle_direction=Angle_R(>0) +Angle_L(>0). If the left and right directions are opposite, for example, the direction control slides rightward by 60 degrees, and the driving control slides leftward by 45 degrees, the steering angles may weaken each other, and a direction of a larger absolute value is finally selected, i.e., Angle_direction=Angle_R (60 degrees)+Angle_L (−45 degrees)=15 degrees. In other words, the vehicle is controlled to turn right by 15 degrees.

As shown in FIG. 18, FIG. 18 is a schematic diagram of a direction angle according to an embodiment of this application. Based on FIG. 18, in a co-connection control mode, a laser lead (a dashed-line in the figure) is displayed in front of a vehicle. The lead is an actual traveling direction of the vehicle, and an included angle between the lead and a direction of a road that is at a certain safe distance (which is preset, for example, 200 meters) ahead is Angle_road. When the vehicle travels on a road, an actual traveling direction direction_car of the vehicle may be obtained, and a direction_forward of the road corresponding to the safe distance may be obtained according to a position of the vehicle and a map configuration, and a planned set safe distance. In this case, Angle_road=direction_forward-direction_car.

In some embodiments, in the co-connection control mode, a difference between Angle_road and Angle_direction is calculated. When a detection result indicates that the difference exceeds a difference threshold, a dangerous mode is entered; otherwise, the mode is a safe mode. The difference threshold is preset and is referred to as Angle_safe. When |(Angle_road-Angle_direction)|>Angle_safe, danger is warned; otherwise, safety is warned.

In this way, the operations that originally require a plurality of operations to implement can now be quickly and efficiently completed, which can significantly improve operating experience of the player and provide more fun for the game.

By applying the foregoing embodiment of this application, in response to a co-connection instruction for a driving control configured to control the virtual object to travel forward or backward and a direction control configured to control the virtual object to turn left or turn right, the driving control and the direction control are controlled to be in the co-connected state. In this way, when the driving control and the direction control are in the co-connected state, in response to the trigger operation for at least one of the driving control and the direction control, the virtual object is controlled to make a turn while traveling. In this way, compared with the manner in the related art in which the driving control and the direction control need to be repeatedly clicked/tapped to adjust the steering process, the driving control and the direction control are controlled to be in the co-connected state, so that only the driving control or the direction control is triggered to implement an effect of controlling the virtual object to make a turn while traveling, thereby improving convenience and effectiveness of the interactive operation, reducing a quantity of adjustment operations performed by the user in the steering process, and improving human-machine interaction efficiency and increasing a utilization rate of hardware resources of the electronic device.

An exemplary structure of the virtual object control apparatus 455 provided in the embodiments of this application implemented as a software module continues to be described below. In some embodiments, as shown in FIG. 2, the virtual object control apparatus 455 in a virtual scene stored in a memory 450 may include:
a display module 4551, configured to display a virtual object in a virtual scene, and display a driving control and a direction control, the driving control being configured to control the virtual object to travel forward or backward, and the direction control being configured to control the virtual object to make a turn;
a first control module 4552, configured to control, in response to a co-connection instruction for the driving control and the direction control, the driving control and the direction control to be in a co-connected state; and
a second control module 4553, configured to control, in response to a trigger operation for a target control, the virtual object to make a turn while traveling when the driving control and the direction control are in the co-connected state, the target control being at least one of the driving control and the direction control.

In some embodiments, the apparatus further includes a first trigger module, the first trigger module being configured to: control, in response to a trigger operation performed simultaneously for the driving control and the direction control, the virtual object to simultaneously perform operations indicated by the driving control and the direction control, and obtain an operation duration of the trigger operation; and trigger the co-connection instruction for the driving control and the direction control when the operation duration of the trigger operation reaches a duration threshold.

In some embodiments, the apparatus further includes a second trigger module, the second trigger module being configured to: keep, in response to a trigger operation performed simultaneously for the driving control and the direction control, a current state of the virtual object unchanged, and obtain an operation duration of the trigger operation; and trigger the co-connection instruction for the driving control and the direction control when the operation duration of the trigger operation reaches a duration threshold.

In some embodiments, the apparatus further includes a state switching module, the state switching module being configured to: display a state switching control when the driving control and the direction control are in the co-connected state; control, in response to a trigger operation for the state switching control, the driving control and the direction control to switch from the co-connected state to a non-co-connected state; and control, in response to the trigger operation for the target control, the virtual object to perform an operation indicated by the target control when the driving control and the direction control are in the non-co-connected state.

In some embodiments, the driving control includes a first driving sub-control configured to control the virtual object to travel forward and a second driving sub-control configured to control the virtual object to travel backward. The direction control includes a first direction sub-control configured to control the virtual object to turn left and a second direction sub-control configured to control the virtual object to turn right. The apparatus further includes a style switching module, the style switching module being configured to switch a display style of each of the first driving sub-control and the first direction sub-control from a default style to a target style when the driving control targeted by the co-connection instruction is the first driving sub-control and the direction control targeted by the co-connection instruction is the first direction sub-control, the target style being configured for distinguishing the first driving sub-control and the first direction sub-control from the second driving sub-control and the second direction sub-control.

In some embodiments, the apparatus further includes a first adjustment module, the first adjustment module being configured to: display a steering angle adjustment control in an associated area of the target control in response to the trigger operation for the target control; and adjust, in response to a steering angle adjustment operation triggered based on the steering angle adjustment control during execution of the trigger operation, a steering angle of the virtual object during the traveling and steering of the virtual object.

In some embodiments, the apparatus further includes a second display module, the second display module being configured to: display an orientation pointer during the execution of the trigger operation, the orientation pointer being configured to indicate a current steering angle of the virtual object; and change a position of the orientation pointer in response to the steering angle adjustment operation triggered based on the steering angle adjustment control, the changed position of the orientation pointer matching a steering angle of the virtual object after the steering angle is adjusted.

In some embodiments, the steering angle adjustment control is in a draggable state. The apparatus further includes a third display module, the third display module being configured to: display a draggable area corresponding to the steering angle adjustment control; and determine, in response to a dragging operation performed on the steering angle adjustment control in the draggable area, the dragging operation as the steering angle adjustment operation.

In some embodiments, the draggable area is a circular area. The first adjustment module is further configured to: obtain a central angle formed by a position of the steering angle adjustment control after being dragged, a position of the steering angle adjustment control before being dragged, and a circle center position of the circular area; and adjust the steering angle of the virtual object based on the central angle.

In some embodiments, the first adjustment module is further configured to: obtain a current steering angle of the virtual object in a traveling process; perform summation on the current steering angle and the steering angle indicated by the steering angle adjustment operation when a direction corresponding to the current steering angle is the same as a direction indicated by the steering angle adjustment operation, to obtain a target steering angle; perform differencing on the current steering angle and the steering angle indicated by the steering angle adjustment operation when the direction corresponding to the current steering angle is opposite to the direction indicated by the steering angle adjustment operation, to obtain a target steering angle; and adjust the steering angle of the virtual object to the target steering angle.

In some embodiments, the apparatus further includes a second adjustment module. The second adjustment module is configured to: obtain a quantity of steering angle adjustment operations performed on the virtual object; and automatically adjust the steering angle of the virtual object to a standard steering angle when the quantity of operations reaches a threshold quantity of times, the standard steering angle being configured for indicating that the virtual object can drive through a turn on a current road turn line at a constant standard steering angle.

In some embodiments, the apparatus further includes a third display module. The third display module is configured to display a guide line corresponding to the virtual object during the traveling and steering of the virtual object, the guide line being configured for indicating an actual traveling direction of the virtual object in the virtual scene.

In some embodiments, the third display module is further configured to: generate, based on a real-time position of the virtual object on a current road turn line during the traveling and steering of the virtual object, a curvature circle corresponding to the real-time position; and generate a tangent line with the real-time position as a tangent point based on the curvature circle, and display the guide line corresponding to the virtual object based on the tangent line.

In some embodiments, the apparatus further includes a fourth display module, the fourth display module being configured to display, during the traveling and steering of the virtual object, first prompt information when the current steering angle of the virtual object during the traveling is consistent with the standard steering angle indicating that the virtual object is able to drive through a turn on the current road turn line, the first prompt information being configured for indicating that the virtual object is able to successfully turn during the traveling.

In some embodiments, the apparatus further includes a fifth display module, the fifth display module being configured to display a guide line and an orientation pointer, the guide line being configured for indicating an actual traveling direction of the virtual object in the virtual scene, and the orientation pointer being configured to indicate the current steering angle of the virtual object. The fourth display module is further configured to display the first prompt information in an associated position of the orientation pointer when the steering angle corresponding to the actual traveling direction indicated by the guide line is consistent with the standard steering angle indicating that the virtual object is able to drive through a turn on the current road turn line.

In some embodiments, the apparatus further includes a third adjustment module, the third adjustment module is configured to: display, during the traveling and steering of the virtual object, an automatic adjustment control when the current steering angle of the virtual object during the traveling is inconsistent with the standard steering angle indicating that the virtual object is able to drive through a turn on the current road turn line, the automatic adjustment control being configured to automatically adjust the steering angle of the virtual object during the traveling; and automatically adjust the steering angle of the virtual object during the traveling in response to a trigger operation for the automatic adjustment control.

In some embodiments, the apparatus further includes a sixth display module, and the sixth display module is configured to: obtain, during the traveling and steering of the virtual object when a direction adjustment operation for the virtual object triggered based on the target control is received, a steering angle indicated by the direction adjustment operation; perform, when a direction corresponding to the steering angle indicated by the direction adjustment operation is the same as a direction indicated by the current steering angle of the virtual object, differencing on the direction corresponding to the steering angle indicated by the direction adjustment operation and the direction indicated by the current steering angle of the virtual object, to obtain a reference steering angle; perform, when a direction corresponding to the steering angle indicated by the direction adjustment operation is opposite to a direction indicated by the current steering angle of the virtual object, summation on the direction corresponding to the steering angle indicated by the direction adjustment operation and the direction indicated by the current steering angle of the virtual object, to obtain a reference steering angle; display danger prompt information when the reference steering angle is greater than a reference steering angle threshold, the danger prompt information being configured for indicating that the virtual object is currently in a dangerous state.

In some embodiments, the first control module 4552 is further configured to: obtain a quantity of co-connections between the driving control and the direction control within a target time period in response to the co-connection instruction for the driving control and the direction control; and control the driving control and the direction control to be in the co-connected state when the quantity of co-connections indicates that the quantity of co-connections between the driving control and the direction control does not reach a threshold quantity of times within the target time period.

In some embodiments, the display module 4551 is further configured to display, in the second virtual space of the virtual scene, a virtual object transmitted from the first virtual space of the virtual scene to the second virtual space. The apparatus further includes a transmission module, the transmission module being configured to transmit the virtual object back to the first virtual space when the virtual object ends a traveling process in the second virtual space.

An embodiment of this application provides a computer program product, inducing a computer-executable instruction, the computer-executable instruction being stored in a non-transitory computer-readable storage medium. A processor of an electronic device reads the computer-executable instruction from the computer-readable storage medium. The processor executes the computer-executable instruction, so that the electronic device performs the foregoing virtual object control method provided in the embodiments of this application.

An embodiment of this application provides a non-transitory computer-readable storage medium, having a computer-executable instruction stored therein, the computer-executable instruction, when executed by a processor, causing the processor to perform the virtual object control method provided in the embodiments of this application, for example, the virtual object control method shown in FIG. 3.

In some embodiments, the computer-readable storage medium may be a memory such as a ROM, a RAM, an erasable programmable read-only memory (EPROM), an electrically erasable programmable read-only memory (EEPROM), a flash memory, a magnetic surface memory, a compact disc, or a CD-ROM; or may be various devices including one of or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or another unit suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially configured for the discussed program, or stored in a plurality of collaborative files (for example, files storing one or more modules, a subprogram, or a code part).

In an example, the computer-executable instruction may be deployed to be executed on one electronic device, or executed on a plurality of electronic devices located at one location, or executed on a plurality of electronic devices distributed at a plurality of locations and connected through a communication network.

Based on the above, the embodiments of this application have the following beneficial effects:

(1) Compared with the manner in the related art in which the driving control and the direction control need to be repeatedly clicked/tapped to adjust the steering process, the driving control and the direction control are controlled to be in the co-connected state, so that only the driving control or the direction control is triggered to implement an effect of controlling the virtual object to make a turn while traveling, thereby improving convenience and effectiveness of the interactive operation, reducing a quantity of adjustment operations performed by the user in the steering process, and improving human-machine interaction efficiency and increasing a utilization rate of hardware resources of the electronic device.

(2) The operations that originally require a plurality of operations to implement can now be quickly and efficiently completed, which can significantly improve operating experience of the player and provide more fun for the game.

In the embodiments of this application, obtaining relevant data such as user operation data is involved. User permission or consent needs to be obtained when the embodiments of this application are applied to specific products or technologies, and the collection, use, and processing of related data need to comply with relevant laws, regulations, and standards of relevant countries and regions.

In the embodiments of this application, the term “module” or “unit” refers to a computer program with a preset function or a part of the computer program and works, together with other related parts, to implement a preset target, and may be completely or partially implemented by using software, hardware (such as a processing circuit or a memory) or a combination thereof. Similarly, one processor (or a plurality of processors or memories) may be configured to implement one or more modules or units. In addition, each module or unit may be a part of an overall module or unit including a function of the module or unit. The foregoing descriptions are only an example of this application and are not intended to limit the scope of protection of this application. Any modification, equivalent replacement, or improvement made within the spirit and principle of this application falls within the protection scope of this application.

What is claimed is:

1. A virtual object control method performed by an electronic device, the method comprising:
displaying a virtual object, a driving control and a direction control in a virtual scene;
in response to a co-connection instruction for the driving control and the direction control, controlling the driving control and the direction control to be in a co-connected state; and
in response to a trigger operation for a target control, controlling the virtual object to make a turn while traveling when the driving control and the direction control are in the co-connected state, the target control being at least one of the driving control and the direction control.

2. The method according to claim 1, further comprising:
in response to a trigger operation performed simultaneously on the driving control and the direction control, controlling the virtual object to simultaneously perform operations indicated by the driving control and the direction control, and obtaining an operation duration of the trigger operation; and
triggering the co-connection instruction for the driving control and the direction control when the operation duration of the trigger operation reaches a duration threshold.

3. The method according to claim 1, further comprising:
in response to a trigger operation performed simultaneously on the driving control and the direction control, keeping a current state of the virtual object unchanged, and obtaining an operation duration of the trigger operation; and
triggering the co-connection instruction for the driving control and the direction control when the operation duration of the trigger operation reaches a duration threshold.

4. The method according to claim 1, further comprising:
displaying a state switching control when the driving control and the direction control are in the co-connected state;
in response to a trigger operation for the state switching control, controlling the driving control and the direction control to switch from the co-connected state to a non-co-connected state; and
in response to the trigger operation for the target control, controlling the virtual object to perform an operation indicated by the target control when the driving control and the direction control are in the non-co-connected state.

5. The method according to claim 1, further comprising:
displaying a steering angle adjustment control in an associated area of the target control in response to the trigger operation for the target control; and
in response to a steering angle adjustment operation triggered based on the steering angle adjustment control during execution of the trigger operation, adjusting a steering angle of the virtual object during the traveling and steering of the virtual object.

6. The method according to claim 1, further comprising:
displaying an orientation pointer during the execution of the trigger operation, the orientation pointer being configured to indicate a current steering angle of the virtual object; and
changing a position of the orientation pointer in response to the steering angle adjustment operation triggered based on the steering angle adjustment control,
the changed position of the orientation pointer matching a steering angle of the virtual object after the steering angle is adjusted.

7. The method according to claim 6, wherein the steering angle adjustment control is in a draggable state, and the method further comprises:
displaying a draggable area corresponding to the steering angle adjustment control; and
determining, in response to a dragging operation performed on the steering angle adjustment control in the draggable area, the dragging operation as the steering angle adjustment operation.

8. The method according to claim 6, wherein the adjusting a steering angle of the virtual object during the traveling and steering of the virtual object comprises:
obtaining a current steering angle of the virtual object during the traveling;
performing summation on the current steering angle and the steering angle indicated by the steering angle adjustment operation when a direction corresponding to the current steering angle is the same as a direction indicated by the steering angle adjustment operation, to obtain a target steering angle;
performing differencing on the current steering angle and the steering angle indicated by the steering angle adjustment operation when the direction corresponding to the current steering angle is opposite to the direction indicated by the steering angle adjustment operation, to obtain a target steering angle; and
adjusting the steering angle of the virtual object to the target steering angle.

9. The method according to claim 6, wherein after the adjusting, in response to a steering angle adjustment operation triggered based on the steering angle adjustment control, a steering angle of the virtual object during the traveling and steering of the virtual object, the method further comprises:
obtaining a quantity of steering angle adjustment operations performed on the virtual object; and
automatically adjusting the steering angle of the virtual object to a standard steering angle when the quantity of operations reaches a threshold quantity of times,
the standard steering angle being configured for indicating a steering angle at which the virtual object is able to drive through a turn on a current road turn line.

10. The method according to claim 1, further comprising:
displaying a guide line corresponding to the virtual object during the traveling and steering of the virtual object,
the guide line being configured for indicating an actual traveling direction of the virtual object in the virtual scene.

11. The method according to claim 1, further comprising:
displaying, during the traveling and steering of the virtual object, first prompt information when the current steering angle of the virtual object during the traveling is consistent with the standard steering angle indicating that the virtual object is able to drive through a turn on the current road turn line,
the first prompt information being configured for indicating that the virtual object is able to successfully turn during the traveling.

12. The method according to claim 1, further comprising:
displaying, during the traveling and steering of the virtual object, an automatic adjustment control when the current steering angle of the virtual object during the traveling is inconsistent with the standard steering angle indicating that the virtual object is able to drive through a turn on the current road turn line; and
automatically adjusting the steering angle of the virtual object during the traveling in response to a trigger operation for the automatic adjustment control.

13. The method according to claim 1, wherein the virtual scene comprises a first virtual space and a second virtual space, and the displaying the first virtual object in the virtual scene comprises:
displaying, in the second virtual space of the virtual scene, a virtual object transmitted from the first virtual space of the virtual scene to the second virtual space; and
transmitting the virtual object back to the first virtual space when the virtual object ends a traveling process in the second virtual space.

14. An electronic device, comprising:
a memory, configured to store a computer-executable instruction; and
a processor, configured to implement a virtual object control method when executing the computer-executable instruction stored in the memory, the method including:
displaying a virtual object, a driving control and a direction control in a virtual scene;
in response to a co-connection instruction for the driving control and the direction control, controlling the driving control and the direction control to be in a co-connected state; and
in response to a trigger operation for a target control, controlling the virtual object to make a turn while traveling when the driving control and the direction control are in the co-connected state, the target control being at least one of the driving control and the direction control.

15. The electronic device according to claim 14, wherein the method further comprises:
in response to a trigger operation performed simultaneously on the driving control and the direction control, controlling the virtual object to simultaneously perform operations indicated by the driving control and the direction control, and obtaining an operation duration of the trigger operation; and
triggering the co-connection instruction for the driving control and the direction control when the operation duration of the trigger operation reaches a duration threshold.

16. The electronic device according to claim 14, wherein the method further comprises:
in response to a trigger operation performed simultaneously on the driving control and the direction control, keeping a current state of the virtual object unchanged, and obtaining an operation duration of the trigger operation; and
triggering the co-connection instruction for the driving control and the direction control when the operation duration of the trigger operation reaches a duration threshold.

17. The electronic device according to claim 14, wherein the method further comprises:
displaying a state switching control when the driving control and the direction control are in the co-connected state;
in response to a trigger operation for the state switching control, controlling the driving control and the direction control to switch from the co-connected state to a non-co-connected state; and
in response to the trigger operation for the target control, controlling the virtual object to perform an operation indicated by the target control when the driving control and the direction control are in the non-co-connected state.

18. The electronic device according to claim 14, wherein the method further comprises:
displaying a steering angle adjustment control in an associated area of the target control in response to the trigger operation for the target control; and
in response to a steering angle adjustment operation triggered based on the steering angle adjustment control during execution of the trigger operation, adjusting a steering angle of the virtual object during the traveling and steering of the virtual object.

19. The electronic device according to claim 14, wherein the virtual scene comprises a first virtual space and a second virtual space, and the displaying the first virtual object in the virtual scene comprises:
displaying, in the second virtual space of the virtual scene, a virtual object transmitted from the first virtual space of the virtual scene to the second virtual space; and
transmitting the virtual object back to the first virtual space when the virtual object ends a traveling process in the second virtual space.

20. A non-transitory computer-readable storage medium, having a computer-executable instruction stored therein, the computer-executable instruction, when executed by a processor of an electronic device, causing the electronic device to implement a virtual object control method including:
displaying a virtual object, a driving control and a direction control in a virtual scene;
in response to a co-connection instruction for the driving control and the direction control, controlling the driving control and the direction control to be in a co-connected state; and
in response to a trigger operation for a target control, controlling the virtual object to make a turn while traveling when the driving control and the direction control are in the co-connected state, the target control being at least one of the driving control and the direction control.
